(19) United States
(12) Patent Application Publication
(10) Pub. No.: US 2024/0257177 A1
(43) Pub. Date: Aug. 1, 2024

(54) Direct Mail Marketing System and Method

(71) Applicant: DIRECTMAIL2.0, LLC, CLEARWATER, FL (US)

(72) Inventors: Bradley S. Kugler, Palm Harbor, FL (US); Sarah Kicinski, Clearwater, FL (US); Joy Gendusa, Clearwater, FL (US)

(21) Appl. No.: 18/632,151

(22) Filed: Apr. 10, 2024

Related U.S. Application Data
(63) Continuation of application No. 17/662,115, filed on May 5, 2022.
Application No. 17/662,115 is a continuation of application No. 16/913,773, filed on Jun. 26, 2020, now abandoned.
(60) Provisional application No. 62/867,740, filed on Jun. 27, 2019.

(51) Int. Cl. G06Q 30/0242; G06K 7/14; G06Q 10/0639; G06Q 10/083; G06Q 10/0833; G06Q 10/107; G06Q 30/018; G06Q 30/0241; G06Q 50/00; G06Q 50/26; G06Q 50/60; H04W 4/029; H04W 84/04

(52) U.S. Cl. CPC G06Q 30/0246; G06K 7/1413; G06Q 10/06393; G06Q 10/0833; G06Q 10/0838; G06Q 10/107; G06Q 30/0185; G06Q 30/0277; G06Q 50/01; G06Q 50/26; G06Q 50/60; H04W 4/029; H04W 84/042

(57) ABSTRACT

The invention relates to a system used to enhance the results of a direct mail marketing campaign. The system processes spanning online and offline efforts with the end result being increased engagement and return on investment through added impressions and real-time Key Performance Indicator (KPI) reporting, in an easy to use and understand dashboard. Additionally, the system has a smart label which communicates with the system of the instant invention to track mail.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### CROSS-REFERENCE TO RELATED APPLICATION

This application is a continuation of U.S. patent application Ser. No. 17/662,115, filed May 5, 2022, entitled Direct Mail Marketing System And Method, which is a continuation of U.S. patent application Ser. No. 16/913,773, filed Jun. 26, 2020, entitled Direct Mail Marketing System And Method, of which claims priority from U.S. Provisional Patent Application No. 62/867,740, filed Jun. 27, 2019, titled Direct Mail Marketing System And Method which are hereby incorporated by reference herein for all purposes.

### BACKGROUND OF THE INVENTION

### 1) Field of the Invention

The invention relates to a system used to enhance the results of direct mail marketing campaign.

### 2) Description of the Related Art

This disclosure generally relates to generating and sending personalized direct mail marketing and providing a way of effectively following up to increase the conversion of direct mail marketing efforts to actual sales. A number of processes are utilized with direct mail including variable printing and offset technology. The typical process using offset technology for sending direct mail to a multitude of recipients, takes up to 24 weeks and will generally deliver the same piece of mail to each recipient of the direct mail. Utilizing variable and digital processes can reduce the time between the proof and the printing process, but the issues with direct mail are similar. The direct mail is completely designed well in advance of mailing including any creative elements as well as any associated offers or promotions, and is intended to be generic or common to each future recipient of the direct mail. Addresses of direct mail recipients are stored in a mailing list and can be added to preprinted direct mail items. Currently, traditional direct mail systems separate the printing and addressing of direct mail into two distinct processes, often performed at two different vendors. First, generic templates of the direct mail are printed without addresses or other personalized information. Next, addresses and fixed personalized details, such as unique promotional codes or names, are added to the already printed templates and subsequently sent for mailing.

Traditional direct mail systems normally print direct mail, and the mailing list used to address the direct mail and the mail is sent to the intended recipient. Consequently, after mailing, there is little tracking of sent direct mail, and statistics of reception or response rate can have limited accuracy as a result. Existing direct mailing systems are slow and inflexible, both in terms of content and in the selection of recipients to receive direct mail. Bulk mailings are impractical, due to the inability to match up addresses to specific recipients in a quick and efficient manner.

The current direct mail process works as follows: A printer/mail house is hired by a business to design, print, acquire a list, and mail to that list, a printed piece offering a promotion.

Printers with offset printing equipment, will need to address the mail pieces using addressing machines in a separate process. Printers with digital equipment include the addresses and other variable data as part of the overall design, and therefore the printing and addressing is simultaneous.

Mailing lists are acquired by the printer/mail house from a list broker or are provided by the business customer. In any event, they need to be “presorted” such that each mail piece has an Intelligent Mail Barcode (“1 MB”) on it for tracking purposes.

Mail houses transmit the mailing and list data to USPS for postage payments, mail tracking, and routine processes.

USPS scans the barcodes on the mail pieces at various stops (delivery units), with the last scan at the delivery destination unit (DDU), but not the final delivery address.

Drawbacks of direct mail as a standalone marketing campaign include:
The mail piece design with a call to action (call a phone number and/or visit a website) directs the recipient (potential customer) to reach into the business. However, the business may not know that the potential customer was directed to their phone number by the specific mail piece. Alternatively, the business will not know whether or not their mail was sent out, let alone delivered to the list at hand. Other issues with direct mail campaign follow-up are that the business will not know who, from the direct mail campaign, visited their website or whether anyone from the direct mail campaign visited their website.

It is important to repeat a marketing message several times before expecting a direct mail recipient to take action, such as making a purchase, and direct mail is the most expensive form of marketing due to the high cost of printing and postage.

Other systems have been developed to address the need for improving the conversion results of direct mail marketing to sales. However, those systems do not provide a system which has specifically timed and sequenced steps, that start with a printed piece of direct mail or a printed advertisement, which is sent to a recipient and allows the advertiser to the follow up to convert the direct mail to quantifiable sales.

Therefore, what is needed in the art is a system that addresses all the complex needs for managing the direct mail follow up process to increase the conversion of direct mail marketing to sales.

### BRIEF SUMMARY OF THE INVENTION

The invention in one form, is a marketing automation, cloud-based technology system. It is designed to achieve an omnipresent and simultaneous marketing campaign, spanning online and offline efforts, with the end result being increased engagement and Return On Investment (ROI) through added impressions and real-time Key Performance Indicator, reporting in an easy to use and understand dashboard.

The increase in the conversion rate of mailings to sales, is accomplished by implementing a structured process that starts with a printed piece of promotion such as direct mail or a printed advertisement. The activities are specifically scheduled to lift the engagement and ROI of the direct mail campaign through timing and placement of ancillary activities, thereby increasing the conversion by 20-50 percent over doing just one of these activities.

The invention in another form provides a direct mail marketing follow up system which allows the marketing personnel, the ability to engage with the recipient of the mail and provide incentives for them to complete the sales cycle.

In yet another form, the invention provides services for marketing that increases the contact level of the company with the recipient of direct mail marketing material.

An advantage of the present invention is the ability to track direct mail and provide email, phone and text marketing to prospective customers to increase the conversion rate of direct mail to purchases.

Another advantage of the present invention is that the customer can decide to purchase the lead information generated from their website and are directly corresponding to the advertiser's direct mail campaign.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 shows a flow chart of the instant invention;

FIG. 2 shows the input screen for adding a client;

FIG. 3 shows the list of jobs and status for a given client;

FIG. 4 shows the input screen for defining a job within the instant invention;

FIG. 5 shows the job information screen within the instant invention;

FIG. 6 shows the job graphics screen within the instant invention;

FIG. 7 shows the online ads setup screen within the instant invention;

FIG. 8 shows the call tracking selection screen within the instant invention;

FIG. 9 shows the call tracking setup screen within the instant invention;

FIG. 10 shows the social media setup screen within the instant invention;

FIG. 11 shows the Lead Match setup screen within the instant invention;

FIG. 12 shows the clients first mailing list upload screen to the system database within the instant invention;

FIG. 13 shows the clients mailing list CSV file upload to the system database screen within the instant invention;

FIG. 14 shows the clients mailing configuration part one reference within the instant invention;

FIG. 15 shows the clients mailing configuration part two within the instant invention;

FIG. 16 shows the clients publish mailing screen within the instant invention;

FIG. 17 shows the mail tracking within the instant invention;

FIG. 18 illustrates the Informed Delivery process of the instant invention;

FIG. 19 shows the USPS service type identifier table for first class mail;

FIG. 20 shows the USPS service type identifier table for USPS marketing mail;

FIG. 21 shows the lead match process of the instant invention;

FIG. 22 shows a summary of the delivery statistics per mailing within the instant invention;

FIG. 23 shows a graph of predicted mail delivery date as well as actual date once mail is confirmed as delivered;

FIG. 24 shows a map of delivery locations at a high level;

FIG. 25 shows a map of delivery locations at a more detailed level;

FIG. 26 shows how a user can filter the table of delivery data;

FIG. 27 shows the Informed Delivery map screen;

FIG. 28 shows the Informed Delivery statistics screen;

FIG. 29 shows the call tracking flow chart one;

FIG. 30 shows the call tracking flow chart two;

FIG. 31 shows the call tracking screen one;

FIG. 32 shows the call tracking screen two;

FIG. 33 shows the call tracking screen three;

FIG. 34 shows a lead match flow chart;

FIG. 35 shows lead match flow chart detail 1;

FIG. 36 shows lead match flow chart detail 2;

FIG. 37 shows one lead match statistics summary screen;

FIG. 38 shows a lead match detail screen;

FIG. 39 shows another lead match statistics graph of leads;

FIG. 40 shows another lead match graph of matches;

FIG. 41 provides the flow for the online follow-up process;

FIG. 42 shows the online follow-up campaign dashboard;

FIG. 43 shows the smart targeting display campaign statistics;

FIG. 44 shows the Social Media Follow-up process;

FIG. 45 shows the Social Media Follow-up statistic screen;

FIG. 46 shows the Social Match flow chart;

FIG. 47 shows the Social Match statistic screen;

FIG. 48 shows a Digitally Trackable Direct Mail process;

FIG. 49 shows the flowchart for email marketing component of the instant invention;

FIG. 50 shows the flowchart for the Hello Leads module;

FIG. 51 shows the customized intelligent reporting performance threshold; and

FIG. 52 shows the Digitally Targeted Ads service flowchart.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art; however, that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token; however, no single feature or features of any described embodiment should be considered essential to every embodiment of the invention, as other embodiments of the invention may omit such features.

In this application, the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

The following terms as used within the description of the invention are defined:
The use of the term “mail” is any physical mail, promotional material, advertisement sent by postal mail to a recipient.
The use of the term “client” is used interchangeably to refer to the user, advertiser or the business in need of a direct mail campaign sold to them by a printer/mail house.
The use of the term “recipient” is any user, individual, home mail address, post office mail address, apartment mail address, condominium mail address or business address who is capable of receiving any physical mail, promotional material, or advertisement sent by postal mail.
The use of the term “e-mail or email” is a basic term referring to Electronic mail which is an Internet service that allows people who have an e-mail address (accounts) to send and receive electronic messages over communications networks and they are used interchangeably within this specification.

The term mail piece refers to piece of actual mail deliverable by the USPS.

The term digital mail is an ad or copy of the mail piece that resembles the mail piece and can be transmitted electronically.

The use of the term “Text or Text messaging” is the transfer of short messages between two or more fixed or mobile devices. Text messaging devices include mobile phones, pagers and personal digital assistants (PDAs). Text messaging originated with the short message service (SMS), which was derived from radiotelegraphy and they are used interchangeably within this specification.

The use of the term electronic communication devices including smartphone and their applications, smart tablet and their applications, and desktop computers and their application, and any derivative thereof, and they are used interchangeably within this specification.

The use of the term smart targeting campaign is a system design to provide tracking of direct mail and allow for the advertiser to follow up with the recipient of the direct mail after the mail has been delivered to the recipient.

The use of the symbol # and the term “the number of,” are used interchangeably, and mean the number of views.

The use of the word lead match and leadmatch, are used interchangeably within this specification.

The term USPS refers to the United States Postal Service.

The invention is a system used to enhance the results of a direct mail marketing campaign. The system processes spanning online and offline efforts, with the end result being increased engagement and ROI, through added impressions and real-time Key Performance Indicator (KPI), reporting in an easy to use and understand dashboard.

The instant invention is a marketing automation, cloud-based technology instant invention. It is designed to achieve an omnipresent and simultaneous marketing campaign spanning online and offline efforts.

The instant invention achieves the increase in performance through twelve (12) specifically timed and sequenced steps, that usually start with a printed piece of promotion such as direct mail or a printed advertisement. The below activities are specifically scheduled to lift the engagement and ROI of the campaign through its timing and placement of these ancillary activities by 20-50 percent over doing just one of these activities.

More specifically, the instant invention is a cloud-based marketing technology software system that combines the data, such as design and mailing lists, from a direct mail campaign with various online marketing technologies that increase engagement and return on marketing investment through added impressions by documenting results and attribution with real-time Key Performance Indicator (KPI) reporting in an easy to use and understand dashboard.

The above is achieved through twelve (12) specifically timed and sequenced steps that usually start with a printed piece of promotion such as direct mail or a printed advertisement. The sequence and timing of these activities is how we re-engage a recipient of a direct mail promotion and convert them into a sale. The twelve direct mail campaign enhancers are shown in the following table:

| Campaign and | | |
|---|---|---|
| Relationship to Direct Mail | Timing | Dashboard Statistics |
| Mail Tracking enables the | Delivery predictions are | Percentage of mail pieces |
| advertiser to predict delivery | displayed once the mailing | delivered. |
| dates so that they can staff | list is published in the | Name, Address and County |
| up for greater volumes of | instant invention by the | of each individual on the |
| leads reaching in. It also | Printer/Mail house. | mailing list with the |
| provides peace of mind | Delivery dates appear | prediction date and the |
| knowing that the mail pieces | shortly after the mail date. | delivered date. |
| are being delivered. | | The stats are detailed in a |
| | | chart, graph and on a map. |
| Informed Delivery provides | Campaign is set up with | Total # emails sent |
| an emailed image of the | USPS 2 to 4 days before the | # times an email was opened |
| direct mail piece to those on | mail date. Campaign lasts 30 | # times an ad was clicked |
| the mailing list just before | days from the mail date. | The stats are detailed in a |
| the mail piece arrives in the | | chart, graph and on a map. |
| residential mailbox. The lead | | |
| can click on the image and | | |
| be taken to a website landing | | |
| page with the offer at hand. | | |
| Call Tracking numbers are | Call tracking is set up before | # Calls Received so far. |
| used on the mail piece so | the mail date such that the | Chart of callers with phone |
| that the advertiser knows | number can be printed on | number, caller demographic |
| which callers are specifically | the mail piece. | data, and the ability to listen |
| from the direct mail | | to the recorded call. |
| campaign. Call tracking also | | The stats are detailed in a |
| enables the advertiser to | | chart, graph and on a map. |
| optimize the reception and | | |
| sales staff pattern for best | | |
| conversion in that | | |
| management is able to listen | | |
| to the sales calls and use the | | |
| recordings for training | | |
| purposes. | | |
| LeadMatch is a technology | LeadMatch is set up on or | # Leads |
| that looks at all visitors to | before the mail date. | # Matches |
| the advertiser's website to | LeadMatch continues until | # Leads purchased |
| determine which visitors | the campaign is completed | Purchased leads include: |
| came from the mailing list. | or canceled. | Date of visit, Name, and |
| Those visitors can be sent | | Address |
| further offers by direct mail | | The stats are detailed in a |
| and other digital follow-up | | chart and graph |
| methods. The other website | | |
| visitors are also identified by | | |
| address so that all visitors to | | |
| the website have the | | |
| potential for follow-up by | | |
| the advertiser. | | |
| Online Follow-up is a | Online Follow-up begins on | # List Members (visitors' |
| Google campaign that shows | or before the mail date, with | cookie) |
| ads that target visitors to the | a smart targeting campaign | # Total Impressions |
| advertiser's website. The | starting immediately, and the | # Total Selects |
| mail piece directs potential | follow-up campaign kicking | # Impressions by date |
| customers to the website or | in, once Google's audience | # Selects by date |
| landing page and these | threshold is met. The | The stats are detailed in a |
| visitors are then shown | campaign continues for 30 | chart and graph |
| banner ads when browsing | days. | |
| websites with similar topics. | | |
| It is a method of repeatedly | | |
| putting the advertiser in | | |
| front of potential customers. | | |
| Social Media Online Follow- | Social Media Online | # List Members (visitors' |
| up is a Facebook and | Follow-up begins on or | cookies) |
| Instagram campaign that | before the mail date once | # Total Impressions |
| shows ads that target visitors | Facebook's audience | # Total Selects |
| to the advertiser's website. | threshold is met. The | # Impressions by date |
| The mail piece directs | campaign continues for 30 | # Selects by date |
| potential customers to the | days. | The stats can be filtered by |
| website or landing page and | | gender and age group. |
| these visitors are then shown | | The stats are detailed in a |
| ads when scrolling through | | chart and graph |
| their feeds. It is a method of | | |
| repeatedly putting the | | |
| advertiser in front of | | |
| potential customers. | | |
| SocialMatch is a social | SocialMatch begins on the | Total # people from the list |
| media campaign based off of | mail date and continues for | that have seen ads |
| the mailing list. It runs ads | 14 days. | # Total Impressions |
| similar to the mail piece on | | # Total Selects |
| Facebook and Instagram | | # Impressions by date |
| specifically to people on the | | # Selects by date |
| mailing list. It is a method of | | The stats can be filtered by |
| repeatedly putting the | | gender and age group. |
| advertiser in front of | | The stats are detailed in a |
| potential customers. | | chart and graph |
| Digitally Targeted Ads is a | Digitally Targeted Ads | # Impressions |
| service that delivers digital | begin on the mail date | # Selects |
| ads directly to the mobile | around the delivery date and | |
| device or computer of the | continue for 15 to 30 days. | |
| person being targeted on the | | |
| mailing list. | | |
| Email Marketing is an email | Email marketing begins on | # email sent |
| ad sent to the person being | or before the mail date and | # emails opened |
| targeted on the mailing list. | continues for 14 days. | # emails clicked |
| Digitally Trackable Direct | Mail date until the delivery | # of pieces of arrived |
| Mail tells the advertiser the | date, if within 10 days of the | # of pieces not arrived |
| exact location of the mail | mail date | |
| piece, through, up to, and | | |
| including delivery to the | | |
| mailbox. This will let the | | |
| sender know when the mail | | |
| arrives and if it doesn't | | |
| arrive, where it is currently | | |
| located. | | |
| HelloLeads is a technology | HelloLeads begin once the | # of new leads |
| that looks at all visitors to | pixel is placed and data | Total number of leads. |
| the advertiser's website, | begins to track. | |
| regardless of a direct mail | | |
| campaign, and provides the | | |
| advertiser with address data | | |
| so that all visitors to the | | |
| website have the potential | | |
| for follow-up by the | | |
| advertiser. | | |
| Scheduled, Customized | Scheduled and customized | Summarizes stats of all the |
| Reporting by Campaign is a | reporting by campaign | active features. |
| push notification that alerts | begins on or before the mail | |
| advertisers, based on their | date and continues until the | |
| selections, of campaign | campaign is completed or | |
| performance. This enables | canceled. | |
| them to tweak and optimize | | |
| the various digital | | |
| campaigns after launch. | | |

The parties which are involved in an Instant invention transaction are as follows:
The client or advertiser is the business in need of a direct mail campaign sold to them by a printer/mail house.
The printer/mail house may be teamed with the Partner because the instant invention operator partners with the printer/mail house to provide insights into the direct mail campaign. These printers/mail houses may provide the design service, the print service, the list acquisition service, the list processing service, the addressing service, and the mailing service.

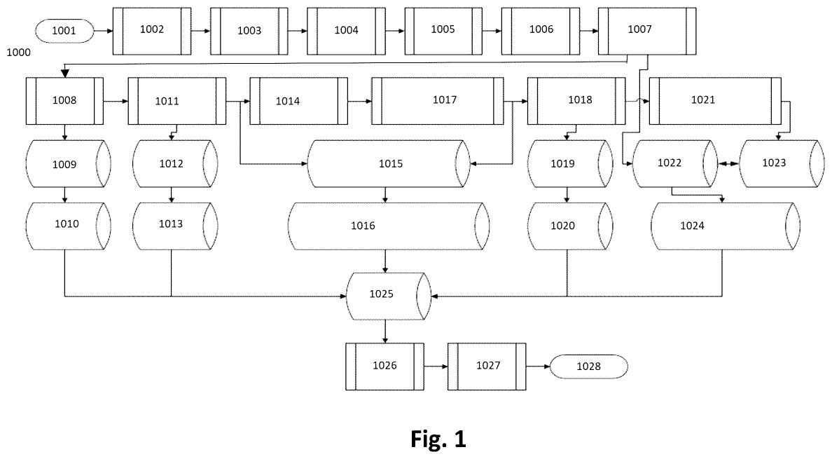

Referring now to the drawings, and more particularly to FIG. 1, there is shown the overall flow chart of the method of the invention, method 1000. Step 1001 is the start of the method 1000 of the invention. The partner creates a new client record step 1002 and then creates a new job for the client step 1003. The partner then sets up the job with a name and number of mail pieces for the job step 1004. The partner then selects the job type step 1005. The partner then configures the job graphics by uploading graphics files step 1006. The partner configures mail tracking step 1007, configures call tracking step 1008, configures online follow-up step 1011 such as using the instant invention versus Google, configures Social Media follow up step 1014, configures Social Match step 1017 and configures Lead Match step 1018. Cookies (Pixels) for online follow-up, Social Media follow-up and LeadMatch are placed into a Google Tag Manager container and the code for that container is placed on the Client's website by the Partner or Client. Any of the invention's features are optional.

If the Partner configures Call Tracking step 1008, then the instant invention interfaces with phone databases, e.g., Twilio and White Pages, step 1009 to provide call tracking stats on the dashboard step 1010.

If the Partner configures Online Follow-up step 1011 then a service provider configured to provide data analytics, e.g., Google, will interface with the invention step 1012 to provide online follow-up stats on the dashboard step 1013.

The Partner configures mail tracking in most cases step 1007. When the partner publishes the mailing list, it will interface with Mr. Mail Tracker step 1022, a proprietary software, and that software will interface with USPS step 1023. The Partner will opt-in for Informed Delivery step 1021 and SocialMatch step 1017 when configuring a mailing. When configured and published, the mail tracking stats and informed delivery stats are displayed on the dashboard of the invention step 1024.

If the Partner configures Social Media Follow-up step 1014, then the invention will interface with a social media, e.g., Facebook, step 1015 to display Social Media Follow-up stats and SocialMatch stats step 1016.

If the Partner opts in for a solution that can track and record exactly who visited a website as a result of a mailing, e.g., LeadMatch, step 1018 then the URL is taken from the Online Follow-up configuration and the invention interfaces with Barometric step 1019 to display LeadMatch stats step 1020. The invention displays stats in graphs, maps step 1025 and tables of data for export to CSV file. Stats continue to accumulate as campaigns continue to run. Once the partner cancels the campaign in the invention step 1026, the staff cancels the campaigns in the interfacing instant inventions such as Google and Facebook step 1027. The process ends step 1028.

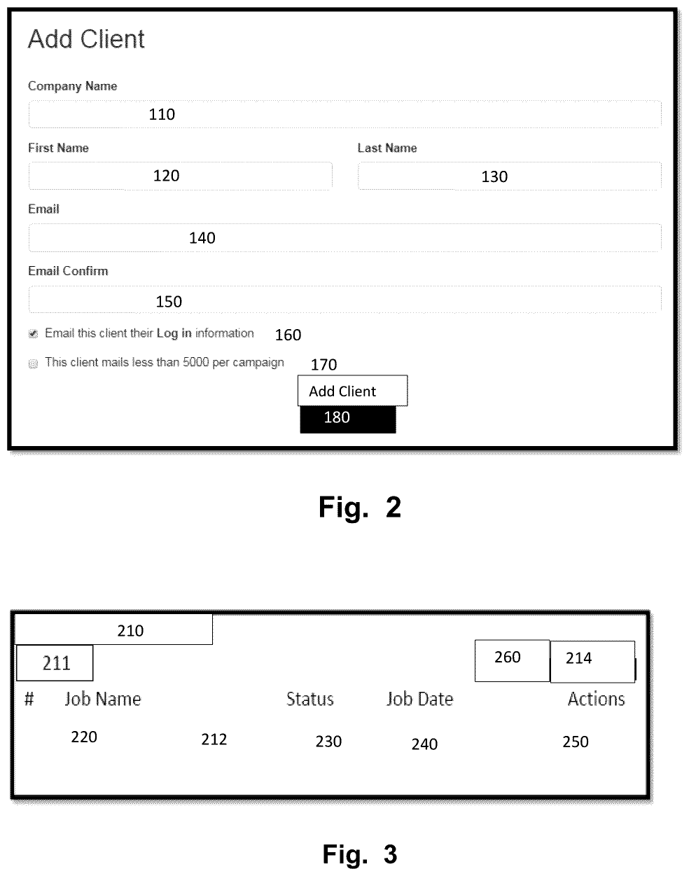

The first step is for the partners to add a new client. The client is defined as the business that is advertising with a direct mail campaign, as shown in FIG. 2. Using the input screen shown in FIG. 2, the Partner types in the Company Name—name of the business they are providing a direct mail campaign to, in step 110, and the First Name step 120, Last Name step 130 and Email address step 140 of the main point of contact and the confirmation email step 150. Then the partner can check the step to send login information to the main point of contact step 160. And the partner can check the box to indicate whether the client mails less than 5,000 pieces per campaign step 170. The Partner then adds the client by clicking on step 180.

The next step is for the Partner to create a job for the client. Using the input screen, shown in FIG. 3, the Partner then creates a new job for the client. There will be decisions to make about the new job in the next step.

The job status screen is shown in FIG. 3, the name of the company is displayed step 210. The partner company job display screen is sorted by the company step 210 and it displays each job step 220 and shows their status step 230, job date 240 and actions 250. The partner selects the create job button to start step 260. They can edit the client by selecting step 211. By selecting step 212 they can create a job, and step 214 allows the user to see the client dashboard.

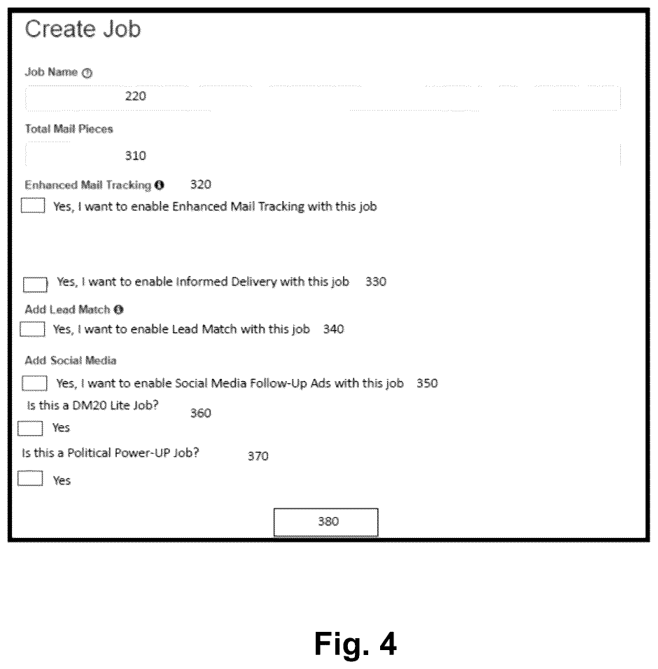

The next step is for the partner to decide which job type and/or services to include in the new job, using FIG. 4. At this point, the Partner types the name of the job in step 220 and the total number of mail pieces into step 310 they expect to mail for this job all at once or over time (days, weeks or months).

Then the partner makes selections based on needs:
Enhanced Mail Tracking module step 320—is the ability to track the mail pieces down to the individual recipient and display those results on a map, as well as a detailed chart. Each mail piece having a specific delivery address. This product will be described in detail later in this document. If the partner does not check off enhanced mail tracking, they will receive standard mail tracking which provides summary delivery data, as opposed to detailed delivery data, provided with enhanced mail tracking. A partner may choose standard mail tracking when they are mailing a non-traceable mail piece.
Informed Delivery step 330—is a USPS offering, where mail recipients receive a daily email informing them of what to expect in their mailbox on a given day. When a mail recipient has signed up for informed delivery, and they are on a mailing list where the business has opted into informed delivery, they will receive a “ride along image” that looks like the direct mail piece. That image is clickable and takes the mail recipient to the business' website, where they can take action toward making a purchase.
Lead Match step 340 is a proprietary offering, where the business can purchase the mailing addresses of visitors to their website, some of which come from the mailing list used for the direct mail campaign. Leads, are visitors to the website, and matches, are those visitors to the website that were also part of the mailing list.
Social Media step 350 includes Facebook and Instagram, which displays digital ads that look like the direct mail piece, and are therefore in a digital mail piece. The ads are shown to visitors of the business' website.

The instant invention uses the Lite function for campaigns involving small mailings. Therefore, step 360 is a job where the mailing list is 2,000 pieces or less per month.

Political Power-Up step 370, is a type of job that includes more and different services, geared toward politicians running for office.

When the partner selects “Purchase Now” step 380, the sales department will charge the partners credit card accordingly.

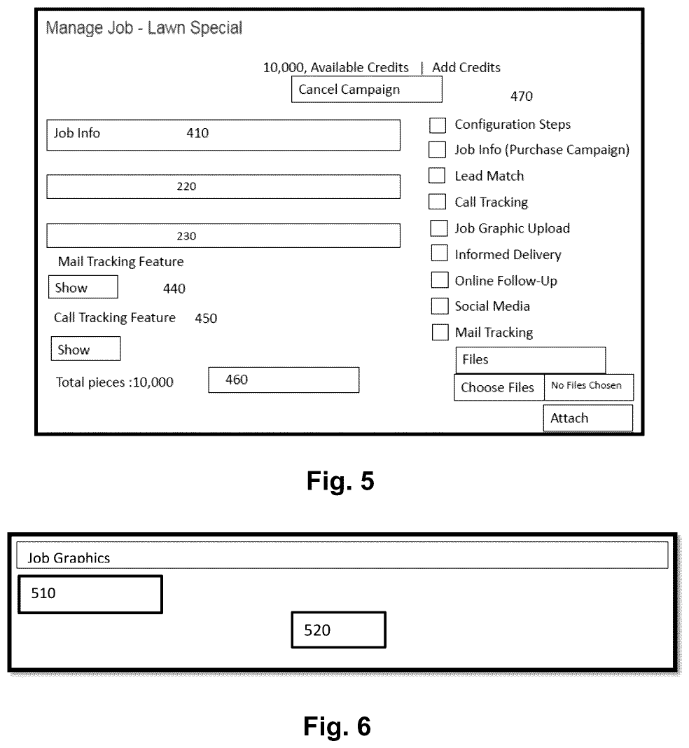

The next step is for the partner to configure the Job using the screen in FIG. 5. First step is to define credits—one credit equals one mail piece. That is the systems unit of payment. The system charges a small fee per credit. Some features cost extra, such as Lead Match.

Assuming that the job is set up for 10,000 mail pieces, nothing has mailed at this point. So, there are 10,000 available credits.

A Partner can cancel a campaign from this screen, or add additional credits if the mailing quantities have changed.

A Partner can opt to hide the mail tracking feature and/or call tracking feature from the client from this screen. If the client, for example, does not want mail tracking or call tracking, then they would not want to see null KPI's on their dashboard for those features. This happens when the mail piece is not traceable, like a bulky magazine, for example. Some clients elect to display their real phone numbers on the mail piece. However, when they elect to use a land line, they will not get call tracking. Therefore, if they elect to use a land line, they will see a null KPI for call tracking on their dashboard.

Furthermore, FIG. 5 shows the job info in step 410 and job name in step 220. The status of the job is shown step 230, the opt-in indicator of the mail tracking feature is shown in step 440, and the opt-in indicator of the call and tracking features in step 450. The Partner then updates the job info by clicking step 460. The configuration steps are shown in step 470. Each of the features listed below the configuration steps, requires some setup data from the Partner. This data will enable systems operating staff and systems to get the online campaigns established.

Next item that the system needs, is the Partner's configuration actions. The purpose of all of this configuration is twofold:
1) to supply the invention with the data needed to set up digital campaigns.
2) to provide data for the client dashboard.

FIG. 6 shows the job graphics screen. This input screen allows the partner to upload a PDF of the mail piece, such as a postcard, front and back. This way, the client dashboard will easily distinguish one campaign from another. There is no limit on the number of graphics that can be uploaded to one job. step 510 is used to add the PDF graphics and step 520 uploads the graphics and associates the graphics with the job name data in the system database.

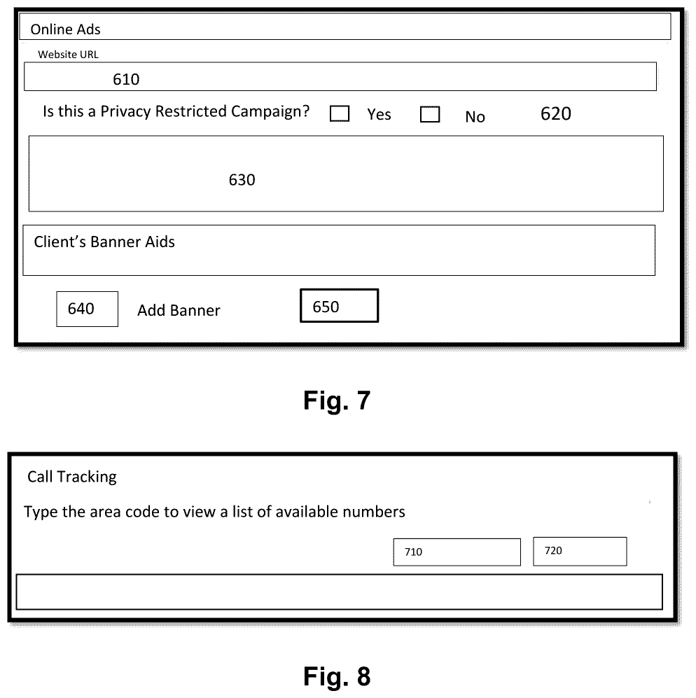

Using FIG. 7, the partner will provide the input for the online ads. The partner will type in their client's website URL step 610, and whether or not the campaign is privacy restricted, step 620, and any optional notes about the campaign step 630. They will upload the banner ads, step 640, and submit the information, Step 650, to the system database.

Using FIG. 8, the partner can set up call tracking. If the partner wants to set up call tracking, they will first determine whether or not they want the enhanced version. The enhanced version, step 710, comes with detailed demographic and location data about the inbound caller, whereas the standard version lists the inbound caller's phone number with no demographic data. Click Create Tracking Phone Number, step 720, to begin the configuration process.

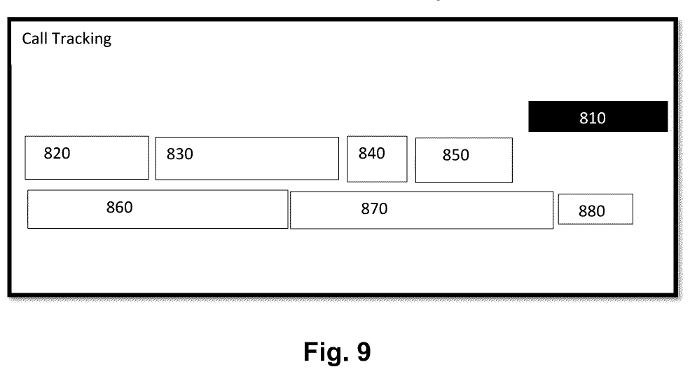

Using FIG. 9 the partner can set up the call tracking specifics. The partner will be able to filter available call tracking phone numbers steps: Area code 820, Contains numbers 830, country code 840 and select one of their choices. They can find available numbers by selecting step 850 which is populated in step 860 with available numbers. Then they would enter the number that it will transfer to step 870 (like the client's receptionists). Then the partner will click the Purchase Number button in order to lock it in step 880. If the partner wants to disable enhanced call tracking, they would click on step 810.

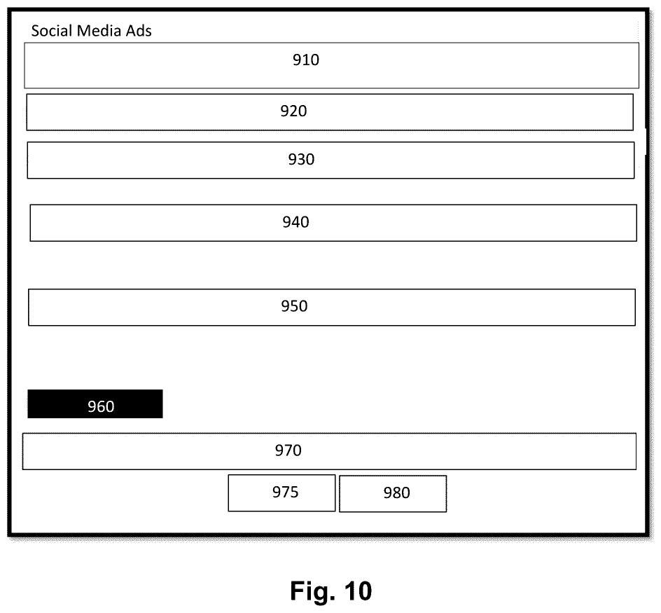

Next using the input screen shown in FIG. 10, allows the partner to set up social media ads. Since the Partner creates their client's ads, they enter the information here so that our staff can set up the campaigns in Facebook and Instagram on their behalf. The website URL is entered into the step 910, the Facebook business page is added to step 920, the headline to be displayed is added to step 930, the description is added to step 940, any notes are placed in step 950, you can add client ads in step 960, and client videos in step 970, and then use step 975 to get the code, and step 980 to submit the data to the system database.

Next, using the Lead Match screen shown in FIG. 11, the partner is configuring the Lead Match feature, they type in the website URL in step 1110, and click Show Lead Match Code 1120. That will expose the pixel that the client needs installed on their website. The partner can select Auto Delivery of Leads, step 1130, if they wish to purchase all leads and then click Update Lead Match Options, step 1140, to save the selections to the database.

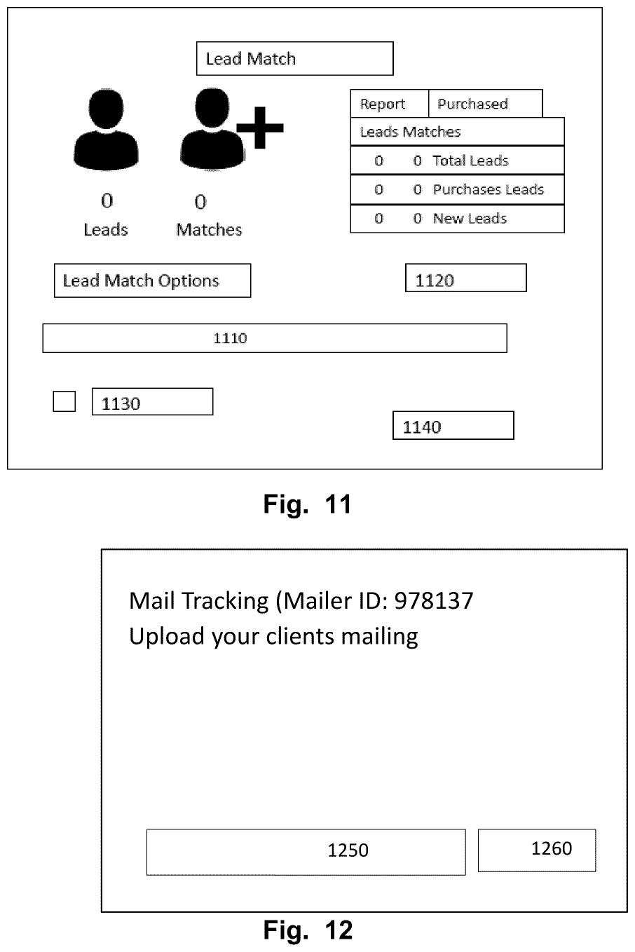

Using FIG. 12, the partner can upload the client's mailing list, using steps 1250 and 1260, and upload process statistics to the system database.

There is a four-step configuration process for each mailing within a campaign. By the time the partner is ready to upload the presorted mailing list, they will have all the data needed to complete the configuration.

First, the Partner will make sure that they processed the mailing list in accordance with the requirements listed. Then the partner will click Upload Client's Mailing List, step 1260.

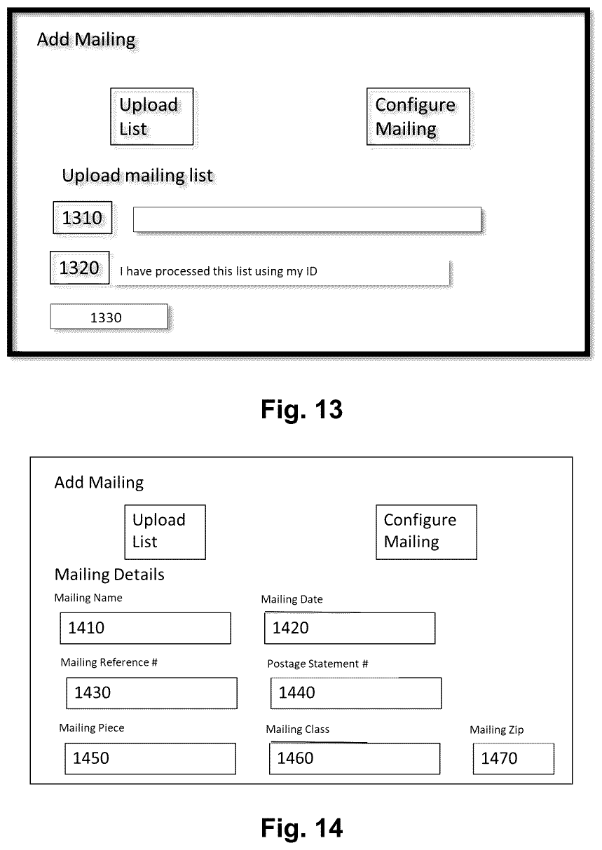

Referring to FIG. 13, allows the partner to select the CSV file step 1310 from their computer drive, and check off that they have used the mailer ID displayed, step 1320 before clicking the Upload List button step 1330.

In the next step, the Partner will configure the mailing list they just uploaded.

Referring to FIG. 14, the Partner enters a Mailing Name step 1410, the Mailing date step 1420, an internal Mailing reference number step 1430, and an optional Postage Statement number step 1440. Then they make selections for the following fields:
Mailing piece: Postcard, Flat, Letterbox 1450;
Mailing class: First, standard, nonprofit step 1460;
Then the Partner enters the mail entry zip code step 1470, which is the zip code from which the mail will enter the mail stream.

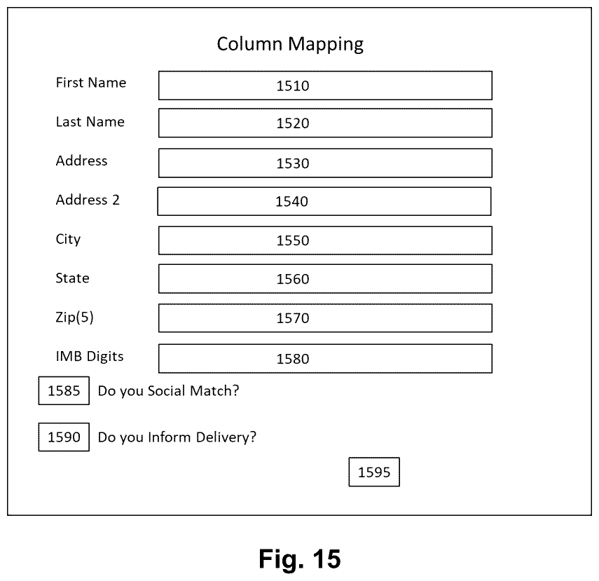

Referring to FIG. 15, the Partner will then map the columns from the mailing list by entering the information in steps 1510, 1520, 1530, 1540, 1550, 1560, 1570, 1580, which may be named randomly to the columns in the Instant invention software system. The only optional field is Address 2 step 1540. The Partner then checks the box to opt-in for Social Match step 1585, if wanted, and the same for Informed Delivery step 1590. The next step is clicking the button Configure Mailing step 1595.

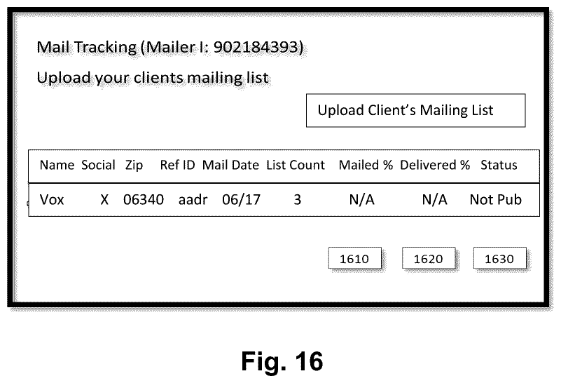

Referring to FIG. 16, the Partner selects the Publish button box to publish the mailing step 1610. They can also edit it step 1620, or delete it step 1630. The instant invention algorithm causes the Instant invention software system to generate projected delivery dates.

Now that the job configuration has been completed in the system, the Partner and Client will work together to place a cookie code into the client's website, created by a tag management system that is used for tracking and analytics on a website, e.g., Google Tag Manager. The partner also makes sure that the client has accepted the one-time Facebook Advertiser request that enables the staff using the Instant invention to manage the social media campaigns.

The instant invention uses an HTTP “cookie”, “also known as a cookie, a web cookie, an Internet cookie, or a browser cookie. The name is a shorter version of “magic cookie,” which is a term for a packet of data that a computer receives, then sends back without changing or altering it. No matter what it is called, a computer cookie consists of information. When you visit a website, the website sends the cookie to your computer. Your computer stores it in a file located inside your web browser.

The purpose of the cookie is to help the website keep track of your visits and activity. For example, many online retailers use cookies to keep track of the items in a user's shopping cart as they explore the site. Without cookies, your shopping cart would reset to zero every time you clicked a new link on the site.

A website might also use cookies to keep a record of your most recent visit or to record your login information. Many people find this useful so that they can store passwords on commonly used sites, or simply so they know what they have visited or downloaded in the past.

Different types of cookies keep track of different activities. Session cookies are used only when a person is actively navigating a website; once you leave the site, the session cookie disappears. Tracking cookies may be used to create long-term records of multiple visits to the same site. Authentication cookies track whether a user is logged in, and if so, under what name.

The instant invention uses cookies, so as to reduce the effort of the client.

Google online follow-up, Social Media online follow-up, and LeadMatch, all require codes, also known as pixels, tags, and cookies, to be placed in the header of the client's website or landing page. Instead of placing various different codes, we use Google Tag Manager code to store the individual codes inside a “container,” so that the client need only place one code, that of the Google Tag Manager; it is less burdensome for the client.

Once the code has been placed, and the advertiser request has been accepted, there is nothing more for the partner to do besides send out the mailing on the mail date, or update the mail date in the software if it has changed.

The code is the technological factor that enables the repetition of the offer for Online Follow-up and LeadMatch. Repetition is the key to success for conversions. The Instant invention provides cost-effective, omni channel repetition, that relates to a specific direct mail campaign to enhance the marketing return on investment.

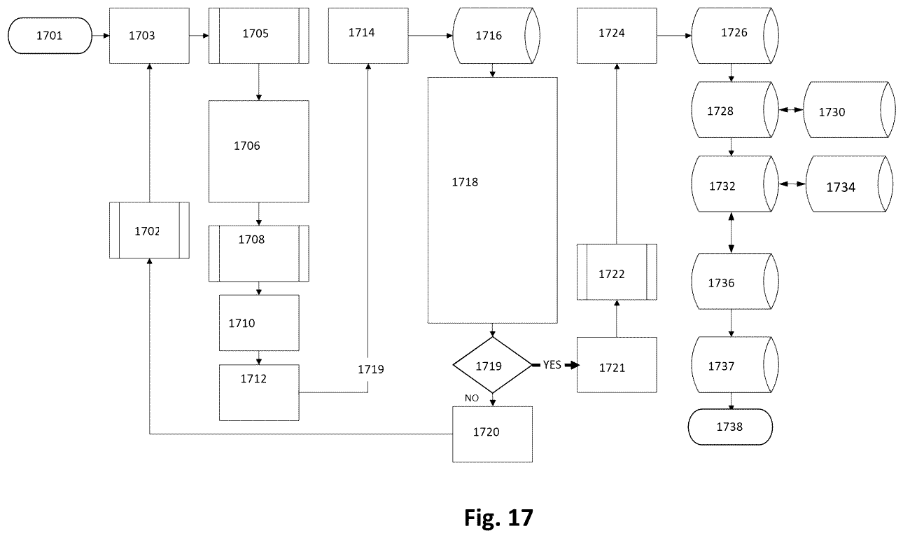

Referring to FIG. 17, the details of the instant invention becomes clearer. The mail tracking process starts at step 1701. Next, the Partner uploads the presorted mailing list step 1703.

The Partner then configures the mailing step 1705.

Steps 1706, 1708, 1710 and 1712 provide detail of the configuration data entered by the Partner. In step 1706, the partner identifies the Mailing Name, Mailing Date, Mailing Reference number, Postage Statement number, Mail piece, Mailing class and Mail entry Zip code; in step 1708, the partner maps lit columns to the instant invention columns; step 1710, the partner is able to select the Social Match option if desired; step 1712, partner is able to select the Informed delivery option if desired.

Step 1714, the Partner selects the: Configure Mailing option

The Instant invention then validates that the mailing list meets the criteria required for mail tracking results to be displayed step 1716, and the criteria are stored on the instant invention database.

Step 1718, there are two required columns: the Intelligent Mail Barcode (“IMB”) Digits and the Zip Code. The IMB is a 65-bar Postal Service™ barcode, used to sort and track letters and flats. It allows mailers to use a single barcode to participate in multiple Postal Service programs simultaneously, expands mailers' ability to track individual mail pieces, and provides greater mail stream visibility. The Intelligent Mail barcode can be applied on Priority Mail® pieces, First-Class Mail® pieces, Standard Mail® pieces, Periodicals, letters and flats, and Bound Printed Matter flats. The Intelligent Mail barcode can be used for IMb Tracing® service, and it can be used for address correction services, manual address correction notices, ACS™, OneCode ACS®, and Intelligent Mail Full-Service ACS™. IMb Tracing® service provides information about when and where the Postal Service sorts a mail piece on mail-processing equipment. Traditional ACS, OneCode ACS, and Full-Service ACS provide mailers with electronic address correction information when a mail piece cannot be delivered as addressed. ACS is a postal mailing service that allows mailers to receive change-of-address (COA) and other reasons for non-delivery electronically, and reduce the number of manual (hardcopy) address notifications.

Basic mail tracking provides the percentage of mail pieces delivered as a summary statistic. It also provides the number of pieces delivered by date.

The zip code may be 5 or 9 digits in length.

Columns must be uniquely named.

The Mailer ID (MID) within the IMB Digits, needs to have been associated with the Customer Registration Identification (CRID) number of the Instant invention. A CRID is a USPS-generated numeric code, of up to 15 digits, that uniquely identifies a business at a location. Each MID is owned by a single CRID at any given time, and each mailing permit, is owned by a single CRID at any given time. However, for mail tracking purposes, the owner of the MID (the Partner or their Mail House) may delegate the MID to the CRID, owned by the Instant invention, for purposes of displaying mail tracking results on the Instant invention dashboard.

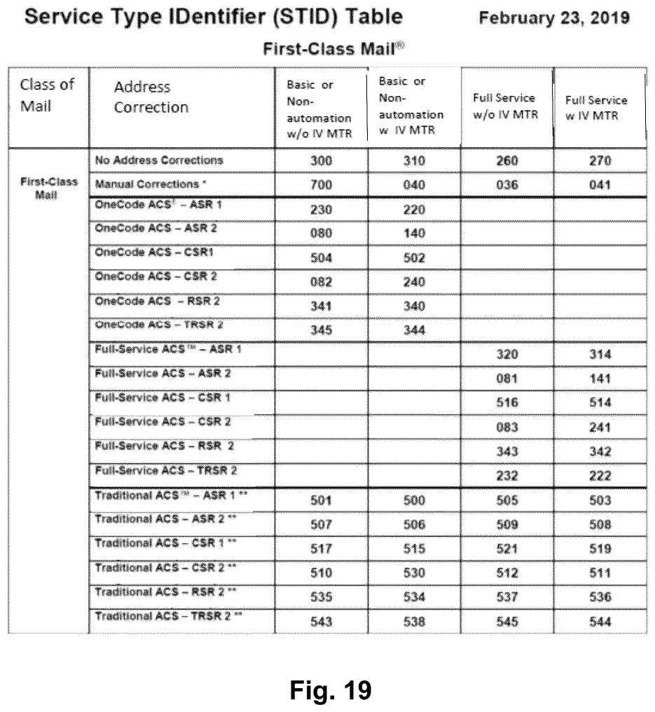

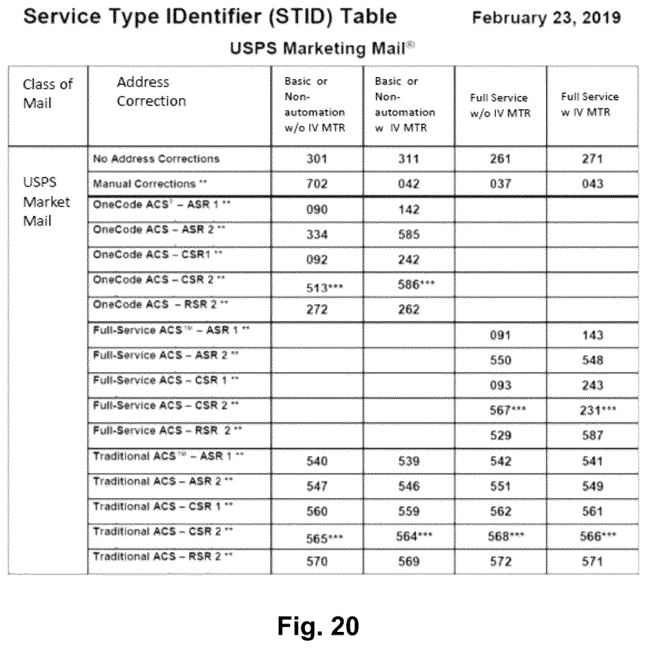

The STID (Service Type IDentifier) is a three-digit numeric code used within the Intelligent Mail® barcode (IMb™) on a mail piece, that identifies the address correction or other electronic services desired. The combination of STID+MID+Serial number within the IMB Digits cannot have been used in the past 45 days. The STID Table, FIG. 19 and FIG. 20, allows you to determine which STID to use based on the mail class, address correction option, use of IMb Tracing™ and whether the mail contains a Full Service or Basic IMb. IMB Digits are between 20 and 31 digits long. Specifically, STID is traceable.

Briefly, IMb Tracing is a service that provides real-time tracking information for automation-compatible letters and flats, giving advance notice for both incoming and outgoing mail.

Destination IMb Tracing service (for outgoing mail) gives advance information about when mail pieces will reach their destination.

Origin IMb Tracing service (for incoming mail) lets you anticipate when customers' checks, replies, or orders are on the way back to you.

For outgoing mail:
Obtain near-real-time notification when your mail receives its last processing scan.
Identify mail delivery trends and ensure delivery is within in-home dates.
Know when your message reached your audience, so you can synchronize multichannel marketing.
Enable fulfillment, staffing, and inventory planning based on mail delivery.

For incoming mail:
Obtain near-real-time notification when your return mail enters the mail stream.
Know when return items are on the way so you can better manage your supply chain.
Manage cash flow and accounts receivable more effectively.
Evaluate the success of advertising campaigns in near real-time

The STID, or USPS service type identifier, among other things, determines whether or not a mail piece is traceable (subject to mail tracking).

If any of the validations fail step 1719, then the Partner will need to correct the list or do without mail tracking. If the validation is not successful, then the system displays an error step 1720, and the partner corrects the error step 1702, and then the partner uploads again, the mailing list step 1703.

Else, if the validation succeeds, then the Instant invention generates a mailing ID unique to the uploaded mailing step 1721. The ID is a combination of the job ID and epoch time stamp, which is the number of seconds that have elapsed since 00:00:00 Thursday, 1 Jan. 1970.

Then the partner is taken to the list publication screen step 1722.

The Partner is redirected to the job configuration screen to publish the mailing.

Once the list is successfully validated, the partner selects the Publish button step 1724.

An API is an Application Programming Interface, which is a set of subroutine definitions, communication protocols, and tools for building software. The Instant invention may interface via an API with a proprietary system, for example, Step 1726, Mr. Mail Tracker (MMT). In general terms, it is a set of clearly defined methods of communication among various components.

Providing further edification as to terminology, a Sectional Center Facility (SCF) is a Processing and Distribution Center of the United States Postal Service (USPS) that serves a designated geographical area defined by one or more three-digit ZIP Code prefixes. A SCF routes mail between local post offices and to and from Network Distribution Centers (NDC).

When a mailing is drop shipped, MMT will relate each given NDC/SCF to their appropriate records in the uploaded mailing list, by relating them to a database of USPS facilities per zip3. For regular mailings, MMT relates each record's zip3 and the origin of the mailing to a database of USPS Service Standards, to create an initial estimated delivery time for each individual mail piece. See steps 1728 where the MMT generates delivery projection dates and 1730 is the USPS facilities database.

MMT then relates each record to stored USPS Informed Visibility piece-level scan data. From this data, it associates any new delivery information, estimated delivery dates, and current whereabouts from the scan data to the record. On an ongoing basis, USPS Informed Visibility sends piece-level scan data via SFTP, (which stands for SSH File Transfer Protocol, or Secure File Transfer Protocol, is a separate protocol packaged with SSH that works in a similar way over a secure connection) to MMT Servers on an hourly basis. MMT takes this data and stores it for long term storage, and associates the new data to existing mailings. See steps 1732 which brings in scans containing matching IMB digits on an hourly basis, and 1734 which is the USPS Informed Visibility Database.

MMT takes a REST API. Representational State Transfer (REST) is a software architectural style, that defines a set of constraints to be used for creating Web services. Web services that conform to the REST architectural style, called RESTful Web services (RWS), provide interoperability between computer systems on the Internet. RWS allow the requesting systems to access and manipulate textual representations of Web resources, by using a uniform and predefined set of stateless operations. Other kinds of Web services, such as SOAP Web services, expose their own arbitrary sets of operations call, from instant invention to sync mailing records daily or nightly, only syncing those records that have had scan updates step 1736.

Mail tracking results include the percentage of mail pieces delivered, the names and addresses from the mailing list with projected and delivery dates. Stats are displayed graphically and on a map step 1737. Step 1737 then transfers the process to Step 1738, which is the end of Mail Tracking process.

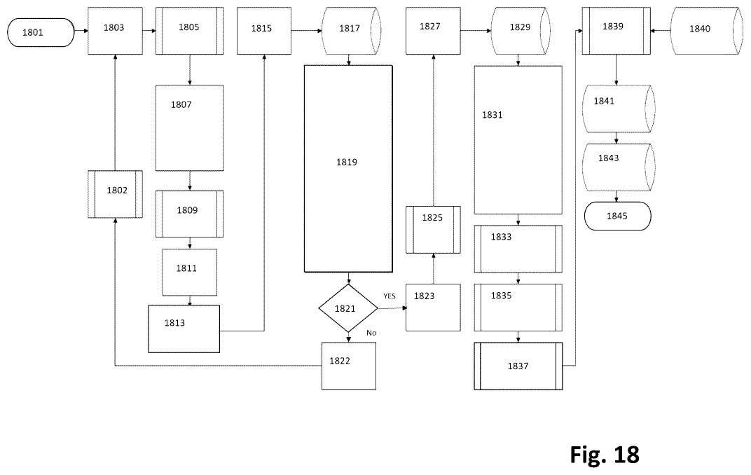

Referring to FIG. 18, it illustrates the Informed Delivery process of the instant invention. Informed Delivery is a USPS offering, where mail recipients receive a daily email informing them of what to expect in their mailbox on a given day. When a mail recipient has signed up for informed delivery, and they are on a mailing list where the business has opted into informed delivery, they will receive a “ride along image” that looks like the direct mail piece. This is part of the USPS Informed Delivery database.

Informed delivery module starts with step 1801. The partner uploads the mailing list in step 1803.

Steps 1805, 1807, 1809, 1811 and 1813 provide detail of the configuration data entered by the Partner. Step 1813, the partner checks the opt-in box for informed delivery.

Step 1805 partner uploads mailing list forming a mailing list campaign.

Step 1807 the partner enters the Mailing Name, which is the mailing list campaign name, Mailing date, Mailing Reference number, Postage Statement, Mail piece, Mail class and Mail entry Zip code.

Step 1809, the partner configures the maps list columns of the informed delivery module step 1801 of the instant invention columns.

Step 1811, the partner selects the Social Match process election box if desired.

Step 1813, the partner selects the informed delivery box if desired.

The partner then selects on the Configure Mailing 1815.

Step 1817, the system checks the mailing list for:
1. Two required columns step 1819: IMB Digits and Zip Code,
2. Zip code needs to be 5 digits or 9 digits,
3. List column headers cannot have duplicate names, cannot be empty, cannot have a numeric header,
4. Mailer ID has to be associated with Instant Invention CRID,
5. STID-Mailer ID-Serial Number within the IMN/B Digits cannot be duplicated (re-used) within 45 days per USPS policy,
6. IMB Digits are between 20 and 31 digits,
7. STID is traceable.

If any of the validations fail step 1821, then the Partner will need to correct the list or do without mail tracking. If the validation is not successful, then the system displays an error step 1822 and the partner corrects the error step 1802 and then the partner uploads again the mailing list step 1803.

Else, if the validation succeeds, the then the Instant invention generates a mailing ID unique to the uploaded mailing step 1823. The ID is a combination of the job ID and epoch time stamp, which is the number of seconds that have elapsed since 00:00:00 Thursday, 1 Jan. 1970.

Then the partner is taken to the list publication screen step 1825.

The partner selects the Publish button step 1827.

The system then generates an email notification to the operator or staff step 1829.

The email contains the data required for the USPS Informed Delivery Setup step 1831. The information included in the email is:
1. Brand Display Name
2. Campaign Title
3. Campaign Code
4. Campaign Start and End Dates
5. Mailer ID
6. Serial Start and End Date
7. A link to the URL and graphic design file.

The staff/operator logs into USPS Informed Delivery Website step 1833.

The staff/operator uses the data provided in the email to set up the campaign step 1835.

One week after the mail date, staff/operator logs in to USPS Informed Delivery to generate standard reports step 1837.

The staff/operator imports USPS reports into the system daily report step 1839. Step 1840, the USPS downloads the email sent, open and click through data to step 1839.

The system matches the USPS data to the campaign code step 1841.

The system displays Informed Deliver Statistics step 1843.

End of the informed delivery step 1845.

The sequence and timing of these activities is how the instant invention reengages a recipient of a direct mail promotion and convert them into a sale.

The instant invention first implementation of Mail-Tracking using the inventions Mail-Tracking module. This has been accomplished by integration with the USPS. The Mail-Tracking module is used to predict and track delivery of mail just as package delivery is tracked. This delivery prediction and confirmation of standard non-profit and first-class mail is done on a graph.

The Mail-Tracking module is a powerful tool which allows the user to create customized reports. The reports can show a variety of information about one or more individual pieces of mail. The Mail-Tracking module can generate reports on individual delivery, non-delivery of pieces, by zip, county, city, and state and by delivery date. The reports can either be displayed, printed, or downloaded.

The invention is not necessarily each individual part, but the whole, and how all the touch points are working together in a specifically timed sequence to reinforce the entire campaign results. That being said, each individual part above has a unique display and reporting feature, and is unique as well, in its own right.

Additionally, further referring to FIG. 18 the instant invention has an informed delivery module 1801 which is opted-in by the Partner while configuring a mailing. See step 1712 from the Mail Tracking flow chart FIG. 17. Once the Partner publishes the mailing (see step 1724 from the Mail Tracking flow chart), FIG. 17. In step 1829, the instant invention generates an email notice to the instant invention staff, with setup instructions for the Informed Delivery campaign. The instant invention generates an email notice to the Instant invention staff with setup instructions for the Informed Delivery campaign.

The email notice of step 1829 has the following required data needed to set up the campaign in USPS. The data is collected and formatted into an email in step 1831 and is as follows:
Brand Display Name—The name of the advertiser (known as the client) in the instant invention
Campaign Title—The name of the job
Campaign Code—Our instant invention uses the job ID-auto incrementing unique ID
Campaign Start Date and End Date—The campaign starts on the mail date and ends 30 days later
Mailer ID—The MID used in the IMB digits of the mailing list
Serial Start and End Date—The first record on the mailing list contains the starting serial number within the IMB Digits. The last record on the mailing list contains the ending serial number within the IMB Digits.

Link to the graphic design in the instant invention

This can either be a specially designed graphics OR

The Google banner ad can be resized and used for Informed Delivery

The link to the website that will be reached when an email recipient selects on the image.

The staff logs in to the Informed Delivery web interface in step 1833.

The staff sets up the campaign using the data from the email notification received in steps 1829 and 1831.

One week after the mail date, the staff logs into the Informed Delivery interface, selects the campaigns, one at a time, and generates the standard, detailed report. The report can then be downloaded as a CSV file. This action is repeated for 14 days per informed delivery campaign.

The staff uploads the CSV file into the instant invention using a standard upload interface. USPS data includes emails sent to Informed Delivery Subscribers, Emails Opened and Ads clicked.

The instant invention matches the uploaded data to the job in the instant invention using the campaign code.

The instant invention displays the Informed Delivery stats on the dashboard.

FIG. 19 shows the USPS service type identifier table for first class mail.

FIG. 20 shows the USPS service type identifier table for USPS marketing mail.

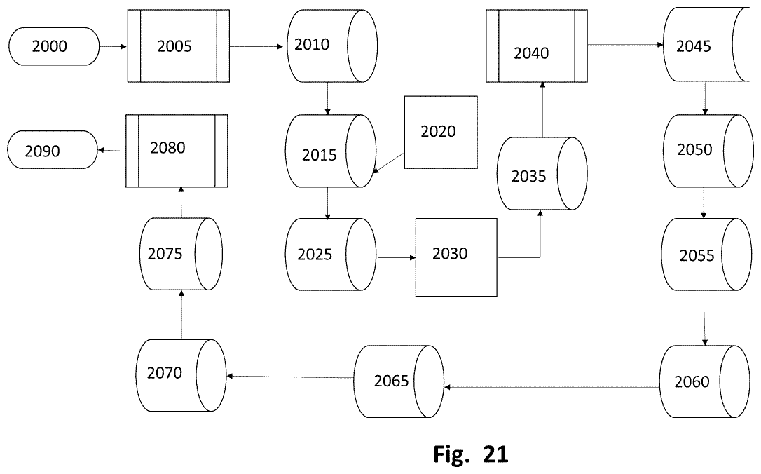

Referring now to FIG. 21, the lead match process system flowchart of the invention. The following process is integrated as part of the invention flowchart of method step 2000. The partner types in the URL into lead match configuration screen step 2005. Then the instant invention transmits the URL to Barometric step 2010. Property ID is a unique ID for the URL: Goal ID is not in use Step 2020. Barometric generate: Pixel (code), property ID and Goal ID step 2015. Barometric stores property ID in the database and server of the instant invention step 2025. Partner initiates show pixel 2030. The instant invention retrieves Pixel from Barometric for that Property ID and displays it on the screen step 2035. The partner retrieves Pixel code and installs it on client website step 2040, Pixel sends IP address and device ID of website visitors to Barometric for analysis step 2045. Barometric uses algorithms to learn which IP address is associated with the visitors' residence step 2050. Barometric interfaces with consumer databases to retrieve residential addresses when there is a match to the residential I.P. address step 2055. The instant invention retrieves the address and time of website visit from Barometric 4 times per day step 2060. The instant invention matches data against stored property ID to active jobs with lead match step 2065. The instant invention will display the number of leads and the number of matches step 2070. The partner can purchase leads and matches in order to view the address data provided by Barometric step 2075. When the partner cancels the job the lead retrieval process stops step 2080. End of lead match step 2090.

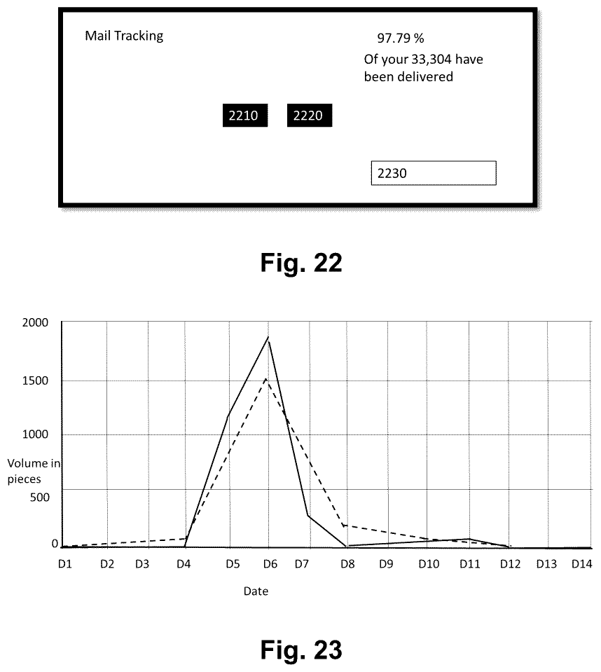

FIG. 22 shows a summary of the delivery statistics per mailing. The user can select either mapping by selecting 2210 or chart by selecting 2220. The user can select the mailing by selecting 2230 and picking a particular mailing.

FIG. 23 shows a graph of predicted mail delivery date as well as actual date, once mail is confirmed as delivered. The solid line is projected, the dashed line is delivered. The invention achieves this by integrating the Mail-Tracking application of the invention with the USPS online systems so that the invention can predict and track the delivery of mail. This delivery prediction and confirmation of standard and first-class mail are done on a graph. In addition, the user can customize reports down to individual delivery and non-delivery of pieces, reports by zip, county, city, and state, all by delivery date, all displayable and downloadable

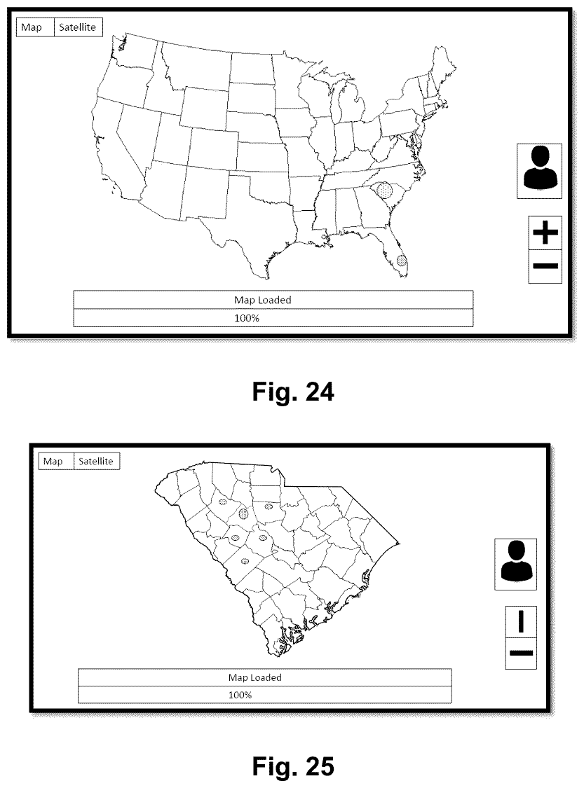

FIG. 24 shows a map of delivery locations at a high level. The circles with the patterned fill show delivery locations, and a location with a large circle indicates more deliveries to that location.

FIG. 25 shows a map of delivery locations at a more detailed level upon drill-down of the post office informed visibility program notifications. The circles with the patterned fill show delivery locations, and a location with a large circle indicates more deliveries to that location.

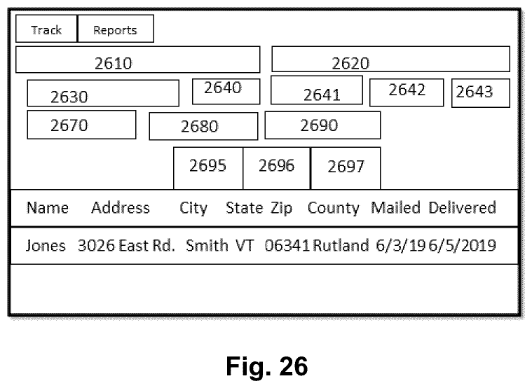

FIG. 26 shows how a user can filter the table of delivery data or scroll through all of it. The detailed delivery data is from the mailing list and includes projected (Mailed column) and delivered dates. The data can be exported for use in a spreadsheet. The user can track on a number of pieces of information: Mailing step 2610, Address step 2620, Date range step 2630, type step 2640, City step 2641, State step 2642, zip code step 2643. First name step 2670, Last name step 2680, county step 2690, and they can track by selecting step 2695, or reset the screen step 2696 or export to a spreadsheet step 2697.

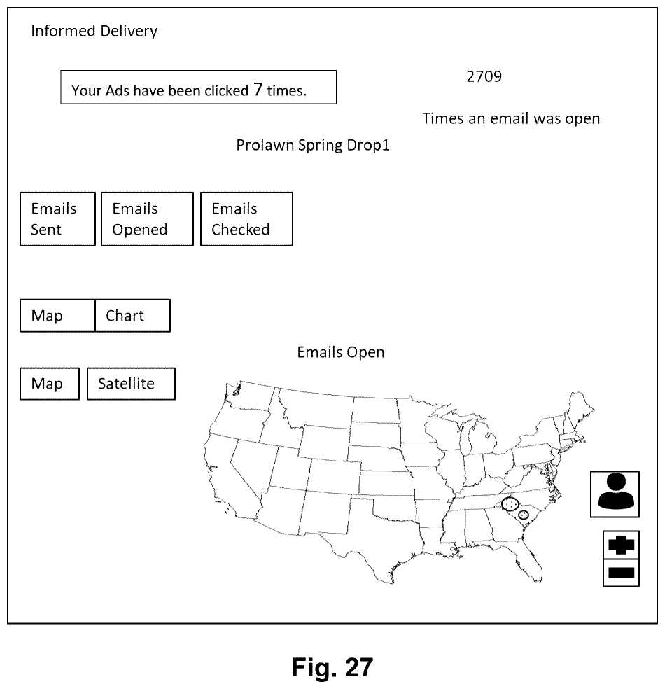

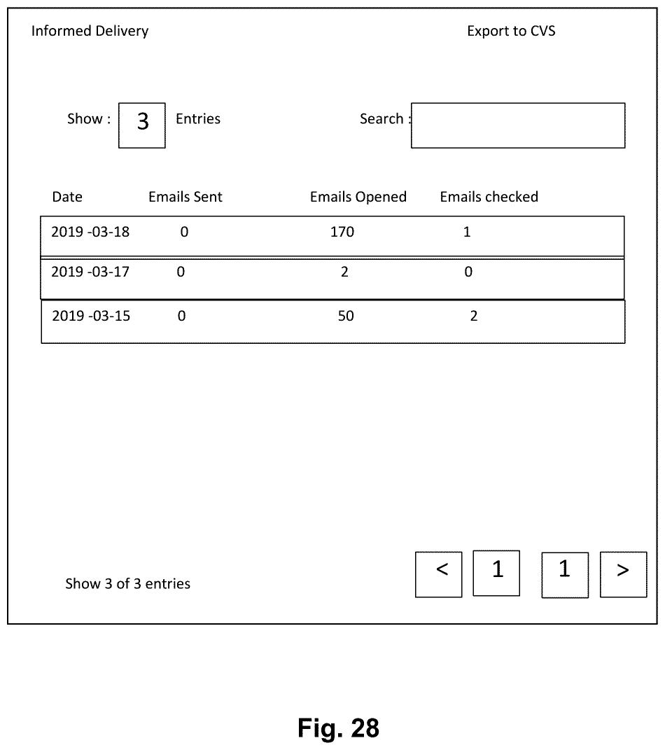

Referring to FIG. 27 and FIG. 28, the Informed Delivery statistics include: the number of times an email was opened, total the number of emails sent, and the number of times an ad was clicked. It can be displayed by plotting the location using the map or on a chart with date information, thereby the delivery information is plotted on a map.

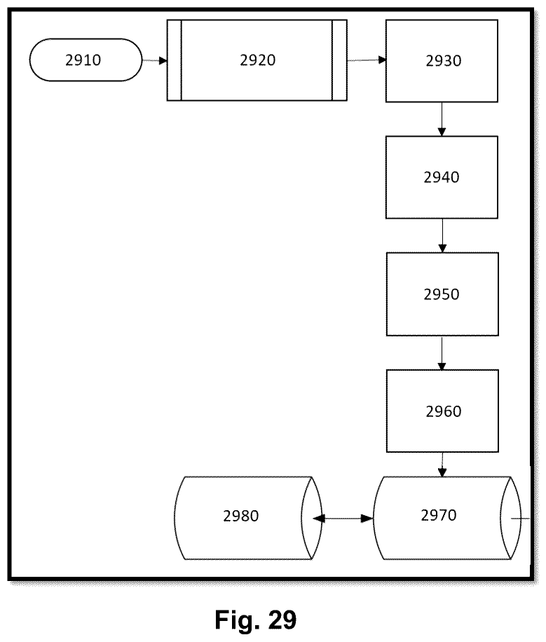

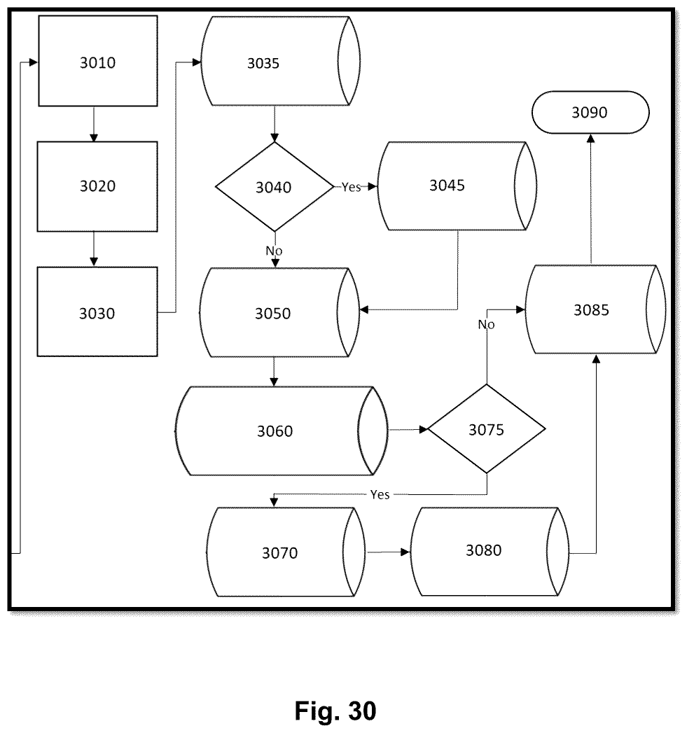

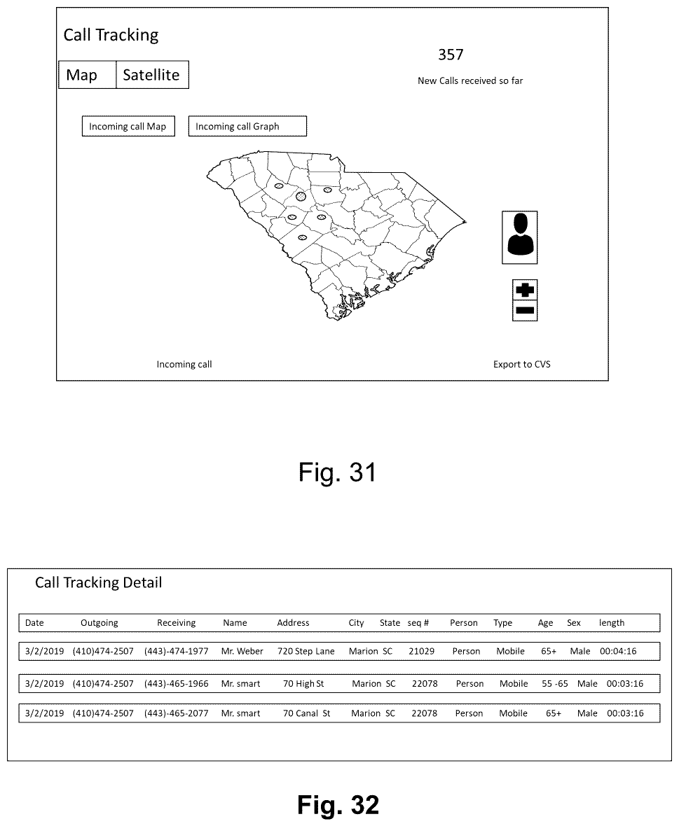

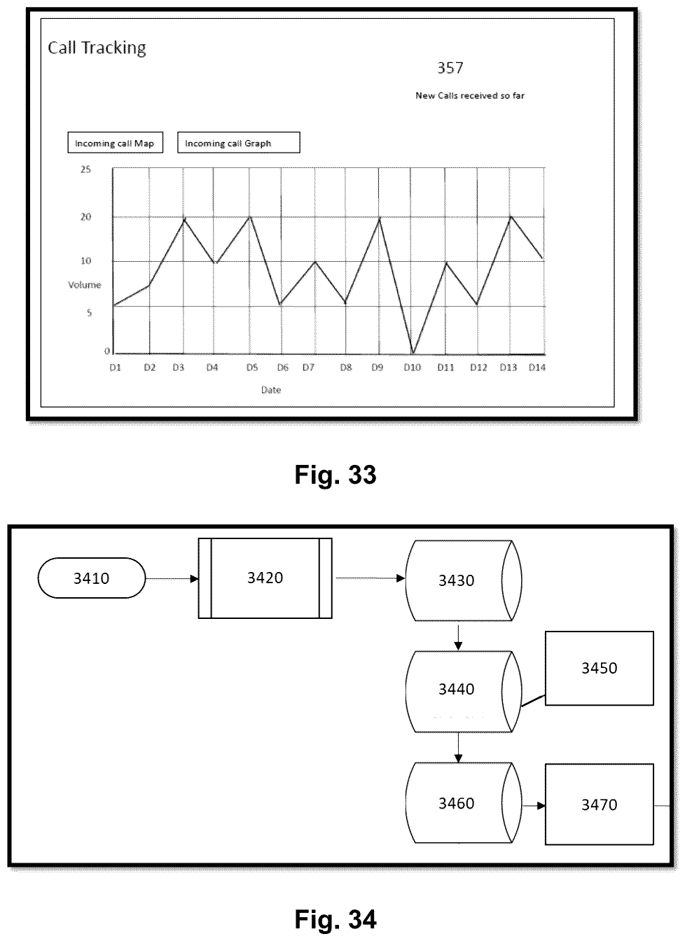

Referring to FIG. 29, FIG. 30, FIG. 31, FIG. 32, and FIG. 33, the instant invention also provides a way of call tracking. If the partner wants to set up call tracking, they will first determine whether or not they want the enhanced version. The enhanced version comes with detailed demographic and location data about the inbound caller, whereas the standard version lists the inbound caller's phone number with no demographic data. Twilio provides available call tracking numbers.

Referring to FIG. 29, the partner will configure the call tracking section of the create job screen, if they decide to print the call tracking number on the mail piece. See Step 2910, start of call tracking, and Step 2920, where the partner is on the job configuration screen, call tracking section.

Referring to step 2930, the partner may opt-in to Enhanced call tracking, to take advantage of the demographic data that is displayed alongside the inbound caller's phone number.

Referring to step 2940, the partner then selects the “create call tracking number” button, to expose the additional fields required for the configuration

Next, the partner at step 2950 types in the desired area code

Then at step 2960, the partner selects the “Find Numbers” button.

The instant invention at step 2970, displays available call tracking numbers. The instant invention at step 2980, ends an API call to Twilio and provides a list of all available call tracking numbers.

The partner selects the desired number step 3010 FIG. 30.

The partner types in the transfer to number to step 3020. This is the number that the call tracking number forwards to. Examples could be the receptionist, the salesman, etc.

The partner selects to purchase the number step 3030. There is no financial transaction taking place because call tracking numbers are included with the overall campaign.

The instant invention sends Twilio the partner's name step 3035

At Step 3040, if the partner is new, then Twilio will automatically set up a sub-account within the master account for a given partner step 3045. If the partner has prior purchases of call tracking numbers, then the subaccount will already exist. In either case, Twilio places the selected call tracking number into the partner's sub account step 3050.

When the mail hits and mail recipients begin to call the phone number on the mail piece, the calls are logged and recorded. Twilio uses a unique ID called a SID for each call. It uses a unique recording ID for each recording of a call. The instant invention sends an API call to update the dashboard with stats twice per day step 3060. If not, then the instant invention transfers control to step 3085 using step 3075.

If the partner opted for enhanced call tacking step 3075, then the instant invention sends an API call to White Pages Pro to retrieve the demographic data of the inbound caller's step 3070.

White Pages Pro will transmit the data back to the instant invention each time the API is called step 3080.

The instant invention displays the call tracking stats, list of calls, and the way to replay the recorded calls step 3085. The recordings are only available to the client or advertiser. The partner has no access to the call recordings. Then the system transfers control to step 3090.

Referring to FIG. 31, the main statistic is the count of new calls received so far. It is displayed on a map by location of caller when enhanced call tracking is selected.

Referring to FIG. 32, the chart that contains demographic data is available only when the partner selects enhanced call tracking. The graphic on the figure is what the partner sees. That is why the call recordings are unavailable. Only when the client logs in to their dashboard, are recordings available for listening.

Referring to FIG. 33, both regular and enhanced call tracking services come with the incoming call graph, which displays the number of calls per day.

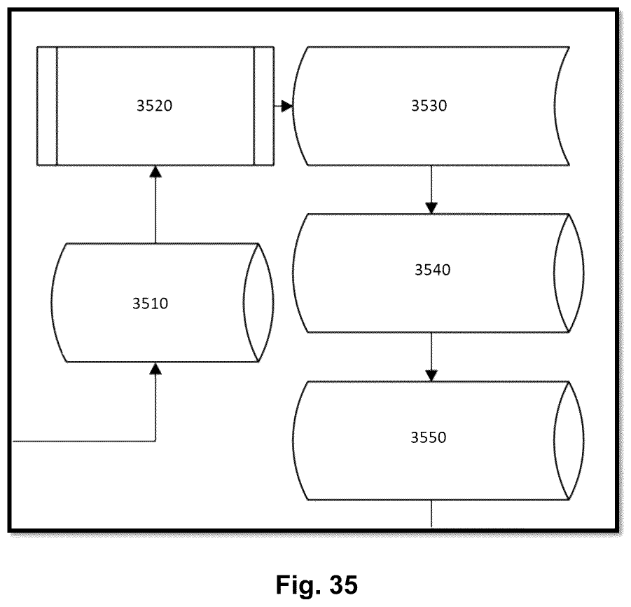

Referring to FIG. 34, FIG. 35, and FIG. 36, Lead Match is a part of the instant invention and is a product that requires the advertiser (client) to place a pixel between the header tags of their website or landing page. This is how the website visitor gets “cookies” so that they can receive follow-up ads, and how the advertiser knows that they have visited the website. The Lead Match algorithm of the instant invention starts at step 3410.

The URL of the advertiser's website is typed into the URL field by the partner step 3420.

The instant invention transmits to Barometric software on a separate Barometric server via API step 3430.

Barometric, once it receives the URL, generates a pixel, a property ID, and a Goal ID step 3440.

The Property ID is a unique ID assigned to the URL shown in step 3450.

Barometric stores the property ID on the instant invention server step 3460.

The partner selects “Show Pixel” step 3470.

Within a period of time, the instant invention retrieves the pixel from Barometric for that property ID and displays it on the dashboard step 3510.

The partner retrieves the pixel code step 3520, and has their client place a pixel between the header tags of their website or landing page.

Once the pixel is placed, it sends the I.P. address and Device ID of all website visitors to Barometric for analysis step 3530.

Barometric uses algorithms to learn which I.P. address is associated with the visitor's residence step 3540.

Then Barometric goes out to consumer databases to retrieve residential addresses, when there is a match to the residential I.P. address step 3550.

The instant invention retrieves the address and time of website visit from Barometric four times per day, step 3660.

The instant invention matches data against stored Property IDs (URL's) to active jobs, where the Partner opted-in to Lead Match step 3650.

From this data, the instant invention compares the address information of the website visitors received from Barometric, to the mailing list addresses, to calculate the number of visitors to the website from the mailing list (called Matches). Any addresses received from Barometric that were not from the mailing list, are called Leads step 3640.

The instant invention enables the Partner to purchase leads and matches, at which time they will be able to view the address data provided step 3630.

Leads and matches continue to accumulate until the partner cancels the job step 3620.

If a job is canceled and a new job is created with the same URL/Property ID in the future for the same client, the Lead Match data will restart at 0. No leads between cancelation and the start of the new job will be captured step 3610.

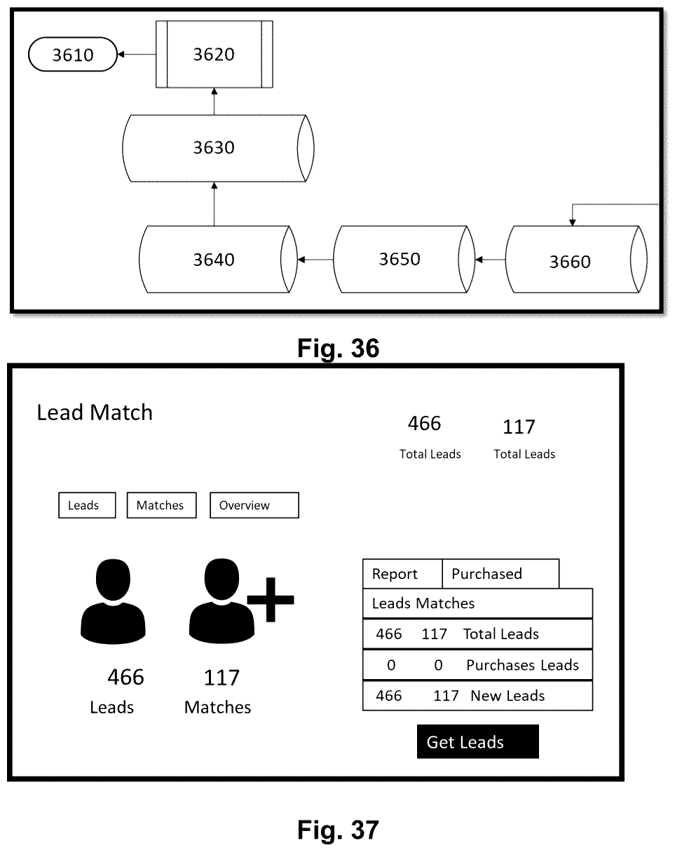

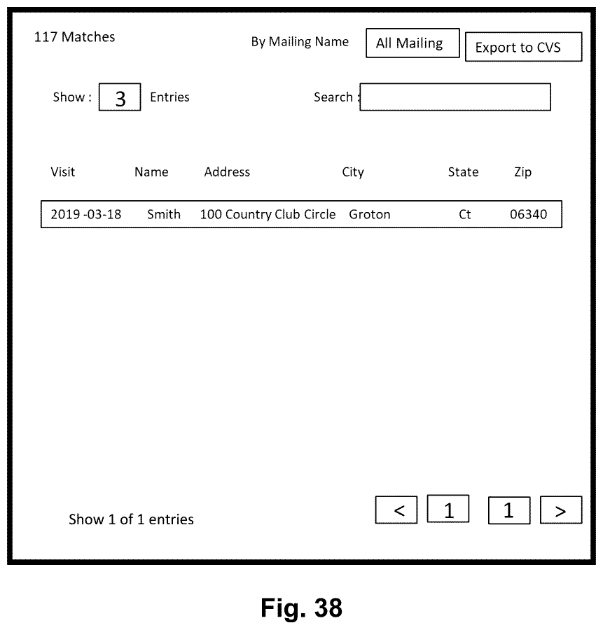

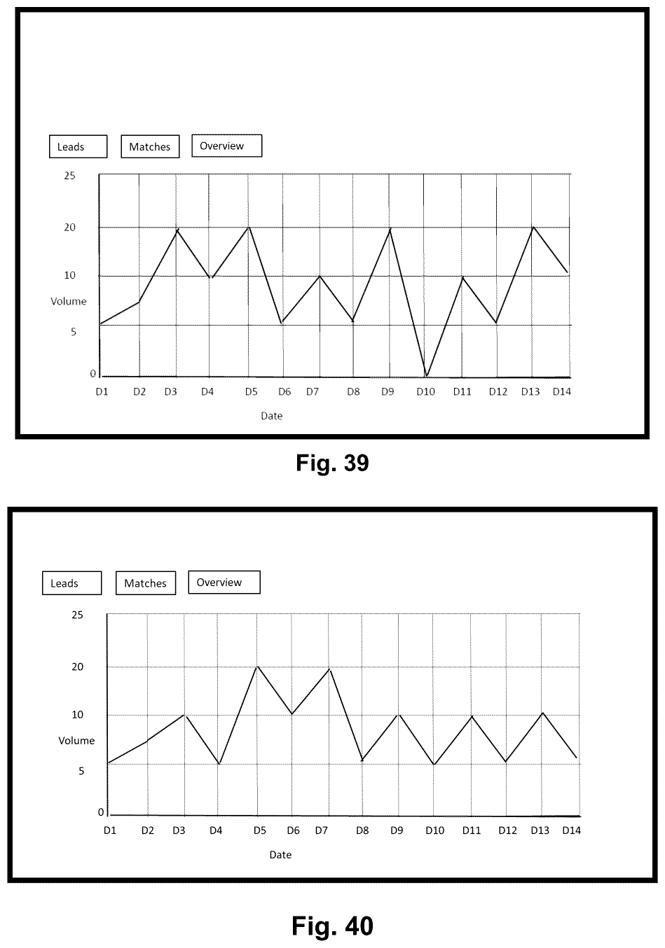

Referring to FIG. 37, FIG. 38, FIG. 39, and FIG. 40, the total leads and total matches are the main statistics displayed. The overview tab shows how many of the total leads have been purchased.

Referring to FIG. 37 and FIG. 38, the list of leads and matches remains blurred until the client selects to purchase the leads. At that point, the client may export them into a spreadsheet.

Referring to FIG. 39 and FIG. 40, the number of leads and matches are each graphed by date.

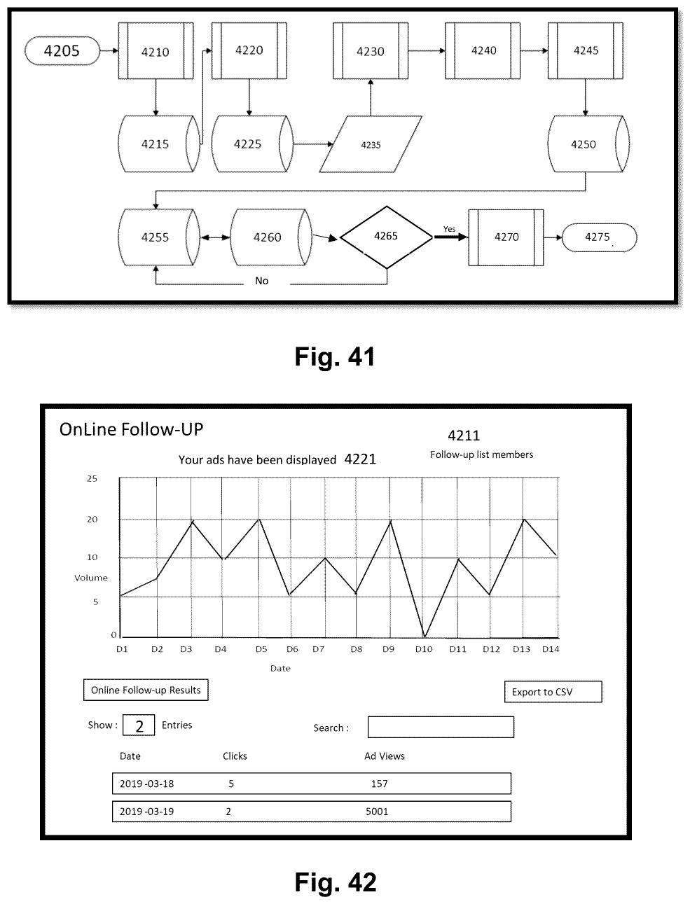

Referring to FIG. 41 Online Follow-up

Online Follow-up is a campaign known as retargeting. The campaign may be Google-based. When a person visits the client's website, a cookie is placed in their browser. This enables the advertiser's banner ads to display as the person surfs the internet. The ads look like the mail piece from the direct mail campaign. The person is able to click on the ad, to get back to the website where they can potentially convert.

It works as follows: site in the “Google Display Network,” you will see ads in the spots rented by Google.

The ad you see is based on what cookies are installed on your browser. Google checks your computer for these cookies and when it detects one, it shows the “Google Follow Up Ad” specific to the site you visited.

The online follow-up campaign works as follows:
The process starts at step 4205. The Partner enters the website URL step 4210 that they want click-throughs to route to. In other words, a person that is surfing the web and comes upon the ad, can click on the ad and land on the webpage associated with the URL entered. The Partner uploads banner ads in three different sizes, that resemble the mail piece step 4215.

Once the Partner publishes the online follow-up campaign, usually a few days before the mail date, the instant invention staff creates an account for the client step 4220, if a first-time setup, an “audience” based on the website URL, Lead Match and Facebook step 4225, and generates a tracking code step 4235 (aka. pixel, cookie, etc.)

The staff stores it in the instant invention and sends it to the Partner step 4230.

The tracking code is actually placed inside a Google Tag Manager container for the client, with codes from Lead Match and Facebook step 4225.

It is the Google Tag Manager code that is remitted to the Partner for installation coordination with their Client.

The Partner coordinates with their client, the advertiser, to install the code into their website, so that it may begin tracking website visitors' step 4240.

The staff sets up the campaign in Google Ads on or before the mail date step 4245.

If the ads are deemed privacy restricted by Google, then the staff will set up a display campaign (called Smart Targeting) that does not involve the installation of a tracking code. Privacy restricted campaigns are generally medical in nature, or target people with financial challenges, amongst other sensitive areas. Step 4250 display campaigns, rather than targeting website visitors, target the general population using geography, keywords and other demographics to narrow the field.

When the ads are not privacy restricted, but the audience or website visitors accumulated since the installation of the tracking is less than 200 in number, the retargeting ads will not start. The number of visitors needed to surpass this Google-mandated threshold is 150 to 200 step 4260.

The staff will set up a Smart Targeting campaign which involves both the display campaign and retargeting campaign. If the website visitors never reach the required threshold, which can happen with direct mail campaigns under 10,000 pieces, the display campaign will be the only one running. But once the threshold has been met, and the retargeting campaign kicks in, the Smart Targeting campaign will be shut off.

The Google ads continue to run step 4255, and the banner ads displayed (known as impressions) begin to accumulate statistics. The statistics include the number of impressions (number of times the banner ads were displayed) and the number of selects which is the number of times the banner ads were clicked on (which routes the person clicking to the website URL).

The instant invention uses an API call twice per day to update the stats displayed to the client in the dashboard. When the campaigns are set up in the instant invention, the Google-generated audience ID and campaign IDs are used to match the campaign in Google, to the campaign in the instant invention.

The ads continue until the Partner cancels the campaign step 4265.

The staff then goes into Google Ads to terminate the campaigns, so that ads stop showing step 4270 and step 4275.

Referring to FIG. 42, the online follow-up campaign dashboard shows the number of list members 4211 (aka audience members), and you can see that they are well over the threshold of 150-200 in number. Therefore, the retargeting campaign is running and the cumulative impressions total 381,401 stored in display 4221. The number of selects and impressions, called Ad Views on the chart, are shown by day in the table below the graph.

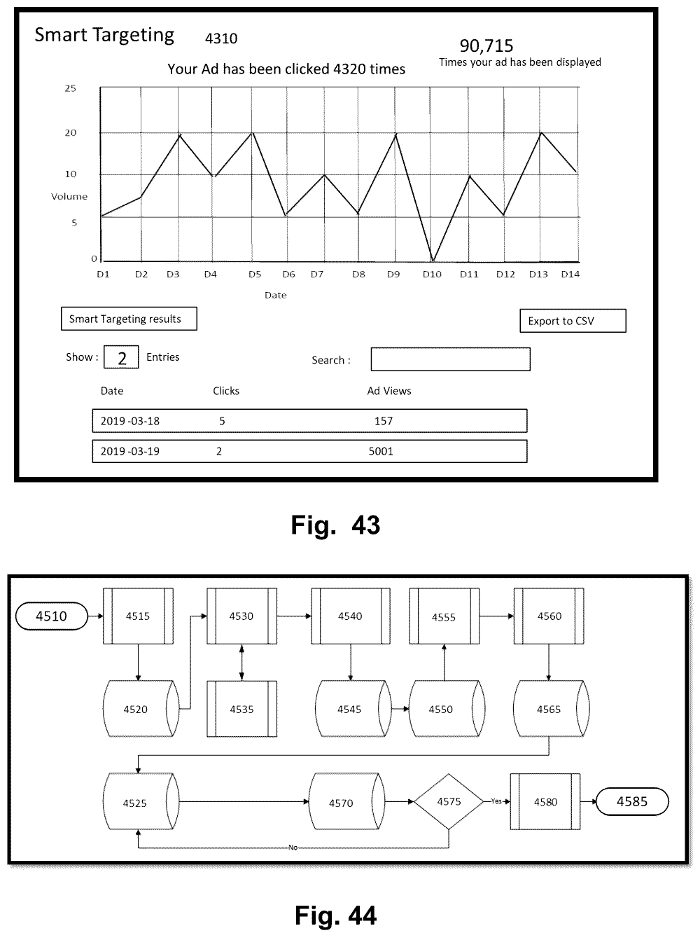

Referring to FIG. 43, the graph is for a display campaign called “Smart Targeting” 4310. It shows the number of impressions and the number of selects as statistics 4320. These stats are shown in the table below the graph as well.

Referring FIG. 44, Social Media Follow-up module process.

Social Media Online Follow-up is retargeting within the Facebook and Instagram systems.

Anyone who goes to the website and is recognized by Facebook as an active user with a profile will receive the cookie known as a pixel. When the visitor logs into Facebook, they will see an ad for the advertiser's company in their news feed.

Continuing to refer to FIG. 44, the partner begins the configuration process of the Social Media Online follow-up campaign step 4510.

The Partner supplies the following information within the instant invention step 4515:
Website URL step 4520.
Facebook Business Page step 4520.
Headline—Short description step 4520.
Description (Ad description) step 4520.
The ad (aka art/design) step 4520.

An advertiser request is sent to the client directly from Facebook and initiated by instant invention staff step 4530. Once accepted, it allows the staff to advertise on behalf of the client. If the request is not accepted, then there can be no ad campaign on behalf of the client step 4535.

The Partner coordinates the installation of the Facebook pixel on the client's website step 4540.

Note that the Facebook Pixel is not unique to the Partner or their clients, but rather to the company. The same pixel is used across all of the instant invention partners and their respective clients step 4545. Therefore, the pixel is hardcoded into the instant invention, as it does not change from website to website step 4550.

The Partner selects a button to publish the campaign in the instant invention once all of the data has been typed into the configuration screen step 4555.

With this data and art, the staff sets up the campaign on Facebook step 4560. Facebook generates unique campaign IDs and the staff inputs the IDs into the instant invention corresponding to the client's job step 4565.

Facebook begins showing retargeting ads to visitors of the website once the audience accumulates around 20 visitors' step 4525. The threshold is significantly less than that of Google. If the threshold is never met, then the ads will never appear on a visitor's profile in their newsfeed. Most of the time, the small threshold is met, and the ads do appear on the visitor's profile in their newsfeed. Note that these ads are shown on Facebook as well as Instagram without any additional configuration steps.

Using an API, the instant invention brings in the stats and displays them on the client dashboard. This updates 2 times per day step 4570.

When the Partner cancels the campaign step 4575 in the instant invention, the staff cancels the campaign on Facebook. See Step 4580 and step 4585.

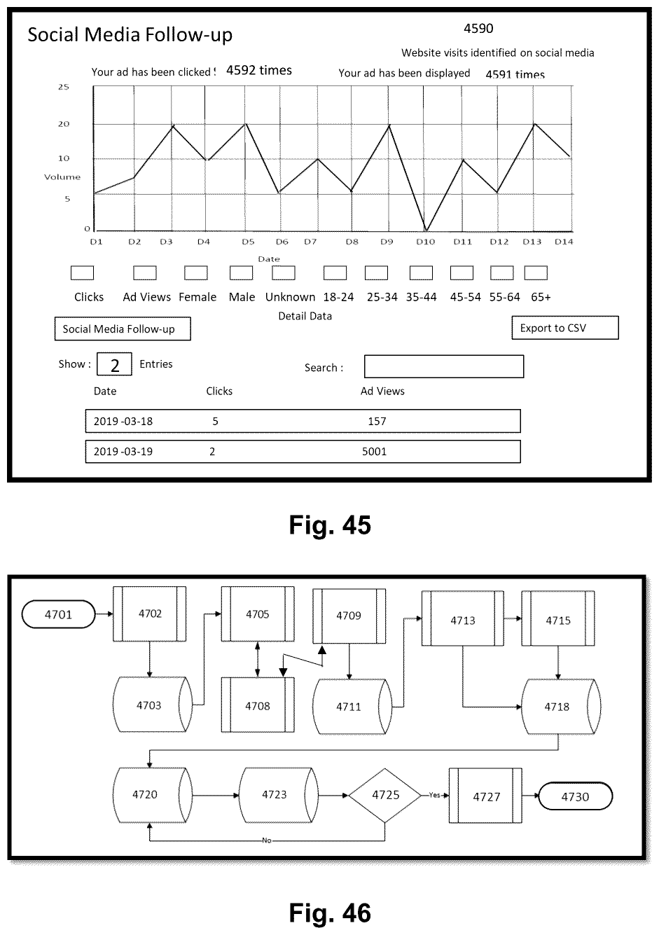

Referring FIG. 45, the Social Media Follow-Up statistics are displayed on the client dashboard. They include the number of times website visitors are identified on Social Media 4590, the number of times ads were displayed 4591 (impressions), and the number of times the ads were clicked 4592. This is shown both on the graph and in the table below by date. The data can be filtered by demographic data such as: female, male, unknown, and various age groups.

Referring to FIG. 46, Social Match involves uploading the mailing list into Facebook to create an audience of mailing list members. If a list member has a Facebook profile and is online, then there is a “match” and Facebook will serve ads on Facebook and Instagram.

The Partner opts-in to Social Match when configuring a mailing step 4701.

Social Match module uses the same configuration data as Social Media Follow-up step 4702, however, the audience is the people on the mailing list as opposed to the people who have visited the advertiser's website step 4703.

The client (advertiser) may accept the advertiser request step 4705 in order for instant invention staff to set up any campaigns on their behalf on Facebook step 4708. It is no different for Social Match.

The Partner publishes the campaign in the instant invention on or before the mail date step 4709. The campaign setup will be delayed, despite the campaign being published, if they are waiting on the client to accept the advertiser request step 4711.

For Social Match, the ad campaign is set up; however, the mailing list is processed to make sure that First Name, Last Name, City, State, and Zip Code are in separate columns. Then the list is uploaded to Facebook step 4713, and set up as an audience for the Social Match campaign step 4715.

Facebook generates a Social Match campaign ID step 4718 (that includes the ID of the mailing list audience as well).

When a list member with a Facebook profile is online, Facebook will begin serving ads step 4720.

The instant invention, via an API, gets the statistics and displays them on the client dashboard step 4723.

The ads continue until the partner cancels the campaign step 4725 in the instant invention.

The staff terminates the campaign on Facebook step 4727 once the campaign has been canceled in the instant invention step 4730.

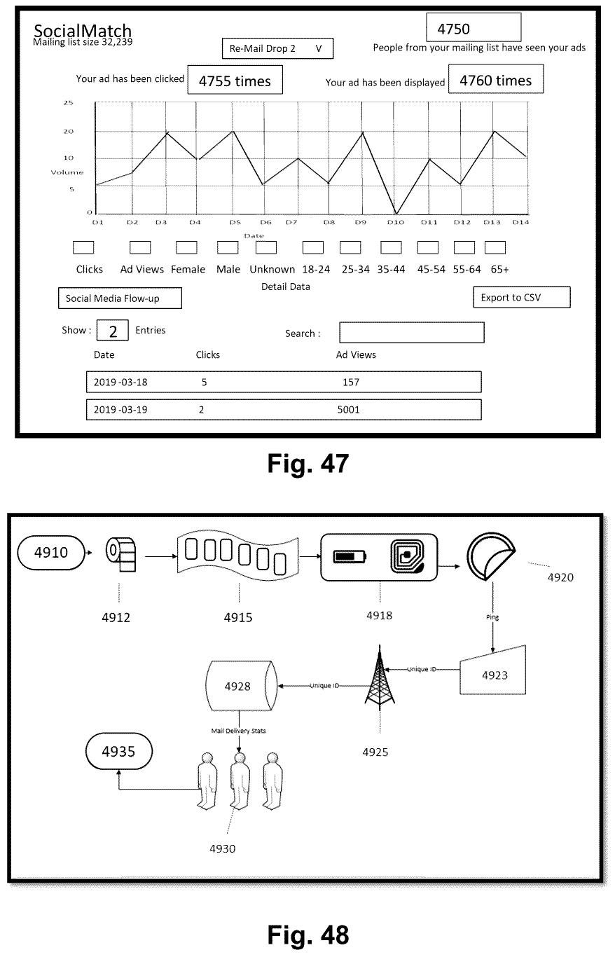

The stats for Social Match are seen in FIG. 47. Number of people from your mailing list who have seen your ads step 4750.

The other stats are a number of selects step 4755 and number of impressions step 4760 with respect to people on the mailing list. The dashboard provides the way of selecting the specific mailing and viewing the stats associated with it. Additionally, the data can be filtered on certain demographics, such as: female or male, and various age groups.

The data is shown on the graph and in the table below the graph shown in FIG. 47.

Digitally Trackable Direct Mail is shown in FIG. 48, and is a technology that involves embedding an RF/Cell tower tracking label on the mail piece, and does not interact with the USPS tracking systems 4910.

Digitally Trackable Direct Mail starts with a roll 4912 of smart labels and 4915 that are equipped with both a power source, e.g., a battery such as 1.5V and a device with digital data identification module, e.g., RFID chip/Cell tower tracking 4918. Each mail/package 4920 with label 4915 is unique, representing the one mail piece. The smart label 4915 is attached to each piece of mail and is detectable by the cellular network 4923. The label pings a low power transmitter that utilizes the cellular networks 4923 to triangulate the location of the mail piece and the low power transmitter using the digital trackable direct mail module, then transfers the triangulate the location to the mail tracking module. The smart label 4915 using the triangulate location, communicates with the digital trackable direct mail module and the mail tracking module of the instant invention.

The digital trackable direct mail module is part of the low power transmitter that utilizes the cellular networks 4923 and is capable of communicating with the label 4915 and the mail tracking module of the instant invention, using the cellular network 4923.

The GPS coordinates along with a piece identifier 4925 will tell the instant invention the exact location of the mail piece and let us know when it is approaching the residence 4928, arrived at the mailbox, and ultimately brought inside the dwelling 4930.

This information will be used to trigger emails 4935 and other digital ads at those specified points.

The Partner uploads their mailing list to the instant invention so that the platform is able to provide data on non-deliveries.

Graphical reports will show the percentage of pieces delivered to mailboxes and ultimately moved into the dwelling and thrown away. This information will be updated several times per day until the power source has been depleted. The power source will also send information as to how much longer tracking information will be sent with each transmission. All information will be downloadable and exportable.

Alternatively the RF/Cell tower tracking mail/package 4920 with smart label 4015, low power transmitter that utilizes the cellular networks 4923 and the USPS Informed Delivery can be integrated into a system where the mail tracking module receives the RF/Cell tower tracking label destination information which is correlated by the mail tracking system with the information from the USPS Informed Delivery database which is on separate USPS servers which are capable of communication with the mail tracking module of the instant invention. The instant invention mail tracking module is capable of providing real time delivery results to the user of the mail tracking system.

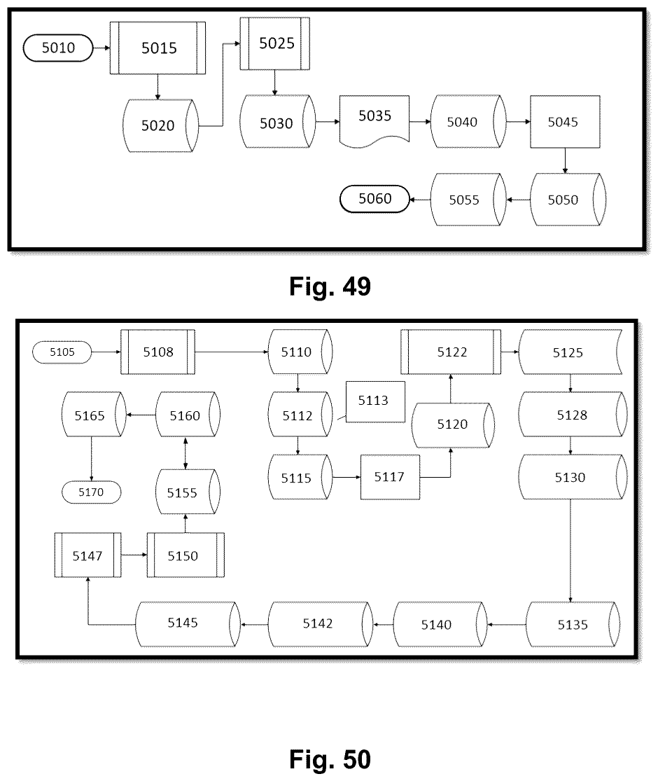

Referring to FIG. 49, email marketing module step S010, coordinated emails, designed like the mail piece, is a point of contact and engagement with the members of the direct mail mailing list.

Partner opts-in to email marketing component of the instant invention.

When the Partner uploads step S015, the mailing list for the mail tracking component, the list includes a column with the corresponding email address.

The email template incorporates step S020 the art files uploaded for the online follow-up campaigns. The Partner can input the wording of the offer and the call to action when configuring the email marketing component of the campaign.

The Partner customizes the email distribution timing and frequency step S025. The email can be sent on or before the mail date and for up to two weeks after the mail date.

The instant invention generates the email content and template from stored data step S030.

The email includes a click-through button step S035 with a call to action and takes the email recipient to the webpage

An email service provider, such as SendGrid step S040, will distribute the emails to the recipient.

The email recipients will open, or click on the offer step S045 and step S050.

The email provider tracks and reports users who engage via API to the instant invention step S055.

The instant invention will report to the client and partner on the number of sends, the number of sends opens and the number of sends selects by the email recipient step S060.

The Hello Leads module is shown in FIG. 50 and is indirectly related to direct mail in that the advertiser (Customer) captures leads from their website, and the instant invention provides the mailing address of those leads to the advertiser. The customer then gets with their printer/mail house to mail to those leads. The customer may opt to include digital ads in which case instant invention can service the customer directly or indirectly, through their printer.

Continuing to refer to FIG. 50 Start Hello Leads step S105.

Customer (is an advertiser) visits the website to sign up to track website visitors and convert them to address information step S108. The customer agrees to pay per lead and they fill in all of the configuration data such as the website URL, reporting frequency, method of notification and contact/payment method information.

The instant invention transmits the URL to Barometric step S110.

Barometric, once it receives the URL, generates a pixel, a property ID and a Goal ID step S112.

The Property ID is a unique ID assigned to the URL step S113.

Barometric stores the property ID on the instant invention server step S115

The pixel is emailed to the customer step S117.

Within a split second, the instant invention retrieves the pixel from Barometric for that property ID and stores it for future retrieval, step S120 should the customer need it re-sent.

The customer installs the pixel onto their website step S122.

Once the pixel is placed, it sends the I.P. address and Device ID of all website visitors to Barometric for analysis step S125.

Barometric uses algorithms to learn which I.P. address is associated with the visitor's residence step S128

Then Barometric goes out to consumer databases to retrieve residential addresses when there is a match to the residential I.P. address step S130

The instant invention retrieves the address and time of website visit from Barometric four times per day step S135.

The instant invention matches data against stored Property IDs (URLs) to customer orders step S140.

The instant invention will email the customer as leads come in or in accordance with the frequency, they specified during the configuration process step S142.

Customer will need to purchase the leads in order to view the residential address data associated with the lead step S145.

The customer decides how to advertise to the leads: direct mail campaign or digital campaigns step S147.

If the customer (advertiser) selects a digital campaign, they can upload digital content and configure the job step S150.

The instant invention will take the digital content supplied and set up the campaigns step S155.

The staff may set up the campaigns in any suitable platform such as Facebook and Google step S160.

The instant invention displays campaign results and emails those results on a customer-selected schedule step S165 and step S170.

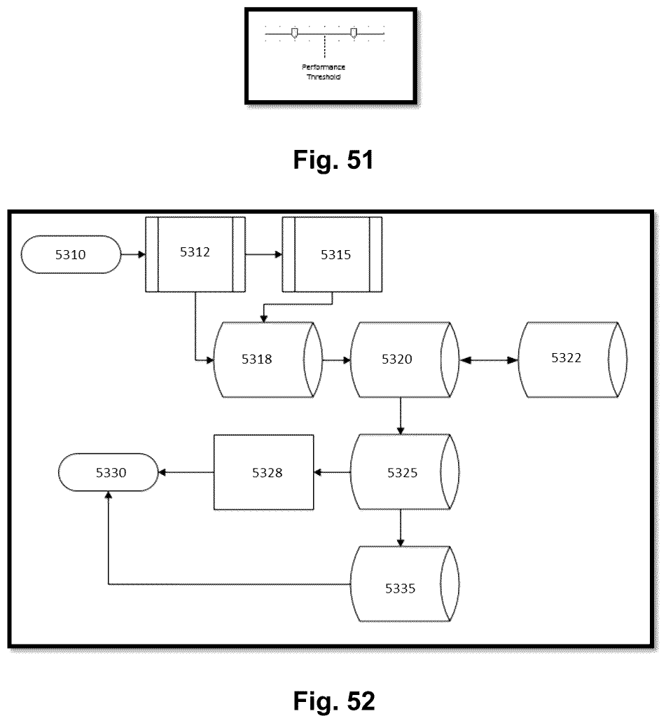

Referring to FIG. 51, the instant invention provides customized intelligent reporting. The instant invention provides a screen where the Partner and Client can customize campaign performance reporting.

For each campaign, the user selects a bottom threshold and a top threshold. The thresholds are in percentages or in volume, depending on the statistic being reported. The user would determine for each statistic, what would trigger an email notification showing the statistic. For example, the user may want to receive an email when mail tracking is at 75%, 8 days after the mail date. For the same campaign, they may want to receive an email when the mail tracking percentage reaches 95%. This example of an upper and lower threshold, applies to all campaigns.

The user may select the method of notification, choosing between SMS text and email. Each notification will include a link to the stats in the dashboard.

Referring to FIG. 52, Digitally Targeted Ads step S310 is a service within the instant invention that delivers digital ads directly to the mobile device or the computer of the person being targeted. The people targeted may come from the mailing list.

Partner opts-in for the digital target ads campaign step S310.

The instant invention uses the mailing list uploaded to the job step S318.

The Partner provides the ads step S315 to be used for the campaign and the instant invention stores this configuration data step S320.

The mailing list is transmitted to the service provider that determines the IP address from the mailing list step S322

The Service provider transmits the IP addresses back to the instant invention server.

The instant invention transmits the IP addresses and the ad content to a DSP (“Demand Side Platform”) of the Instant invention step S325. The provider supplied ads are served to the mail list members or recipients step S328. Additionally, the DSP provides stats including the number of times delivered to specific IP/mail recipient, the number of selects and who clicked and to which device the ad was delivered.

The instant invention displays the stats graphically and in a table step S330.

Mailing list recipients see the ads and can click through step S335.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within the known or customary practice in the art to which this invention pertains and which fall within the limits of the appended claims.

What is claimed is:

1. A direct mail marketing campaign system to track a mail piece and provide email marketing to a recipient comprising:
a. said mail piece having a specific delivery address and a smart label attached to said mail piece and said specific delivery address naming said recipient;
b. a digital mail piece representing said mail piece; and
c. a computerized system and said computerized system comprising:
i. a mail tracking module to track said mail piece;
ii. an informed delivery module;
iii. a leadmatch module;
iv. a call tracking module;
v. a social match module;
vi. a social media follow-up module;
vii. an online follow-up module;
viii. an email marketing module;
ix. an enhanced mail tracking module;
x. a hello lead module; and
d. said smart label attached to said mail piece has a digital data identification module and a battery;
e. said email marketing module is in communication with said mail tracking module, said informed delivery module, said leadmatch module, said call tracking module, said social match module, said social media follow-up module, said online follow-up module, said enhanced mail tracking module; and
f. said email marketing module retrieves an email address of said recipient using said mail tracking module and sends said recipient an email with said digital mail piece.

2. The direct mail marketing campaign system of claim 1 wherein said digital data identification module is in communication with a cellular network and said mail tracking module having a digital trackable direct mail module is in communication with said cellular network and said digital trackable direct mail module communicates with said mail tracking module.

3. The direct mail marketing campaign system of claim 1 wherein said digital data identification module using said cellular network triangulates the location of said smart label attached to said mail piece.

4. The direct mail marketing campaign system of claim 1 wherein said digital data identification module using said cellular network communicates said location of said smart label attached to said mail piece to said digital trackable direct mail module.

5. The direct mail marketing campaign system of claim 1 wherein said digital trackable direct mail module communicates said location of said smart label to said mail tracking module.

6. The direct mail marketing campaign system of claim 1 wherein said location of said smart label is compared to said specific delivery address and if said location of said smart label is the same as said specific delivery address then said email marketing module retrieves an email address of said recipient at said specific delivery address using said mail tracking module and sends said recipient an email with said digital mail piece.
